(19) United States
(12) Patent Application Publication
(10) Pub. No.: US 2026/0287859 A1
(43) Pub. Date: Sep. 24, 2026

(54) IMAGING OPTICAL SYSTEM, PROJECTION TYPE DISPLAY DEVICE, AND IMAGING APPARATUS

(71) Applicant: FUJIFILM Corporation, Tokyo (JP)

(72) Inventor: Taku FURUBAYASHI, Saitama (JP)

(73) Assignee: FUJIFILM Corporation, Tokyo (JP)

(21) Appl. No.: 19/558,130

(22) Filed: Mar. 5, 2026

(30) Foreign Application Priority Data
Mar. 21, 2025 (JP) 2025-047318

(51) Int. Cl. G02B 13/00; G02B 9/64; G02B 13/02; G02B 27/01

(52) U.S. Cl. CPC G02B 13/0045; G02B 9/64; G02B 13/009; G02B 13/02; G02B 27/0172

(57) ABSTRACT

An imaging optical system consists of, in order from a magnification side to a reduction side, a first optical system and a second optical system, and forms, in the imaging optical system, an intermediate image at a position conjugate to a magnification-side imaging plane. The first optical system and the second optical system are separated by a maximum air spacing among air spacings between lenses on an optical axis on the reduction side with respect to the intermediate image. The first optical system includes a lens surface having a concave shape adjacent to the intermediate image on the magnification side, and a lens surface having a concave shape adjacent to the intermediate image on the reduction side. A lens surface of the first optical system closest to the reduction side has a concave shape. The imaging optical system satisfies a predetermined conditional expression.

### CROSS-REFERENCE TO RELATED APPLICATIONS

This application claims priority from Japanese Patent Application No. 2025-047318, filed on Mar. 21, 2025, the entire disclosure of which is incorporated herein by reference.

### BACKGROUND

### Technical Field

The disclosed technology relates to an imaging optical system, a projection type display device, and an imaging apparatus.

### Related Art

Optical systems according to WO2021/152968A and WO2023/243154A are known as imaging optical systems applicable to a projection type display device or an imaging apparatus.

### SUMMARY

An imaging optical system that is an optical system forming an intermediate image, has an appropriate air spacing, is reduced in size, and maintains favorable optical performance is required. A level of such demand is increasing year by year.

The present disclosure is conceived in view of the above circumstances, and provides an imaging optical system that is an optical system forming an intermediate image, has an appropriate air spacing, is reduced in size, and maintains favorable optical performance, a projection type display device comprising the imaging optical system, and an imaging apparatus comprising the imaging optical system.

According to an aspect of the present disclosure, there is provided an imaging optical system that conjugates a reduction-side imaging plane and a magnification-side imaging plane each other, forms, in the imaging optical system, an intermediate image at a position conjugate to the magnification-side imaging plane, and consists of, in order from a magnification side to a reduction side along an optical path, a first optical system and a second optical system, in which the first optical system and the second optical system are separated by a maximum air spacing among air spacings between lenses on an optical axis on the reduction side with respect to the intermediate image, the first optical system includes a lens surface having a concave shape adjacent to the intermediate image on the magnification side, and a lens surface having a concave shape adjacent to the intermediate image on the reduction side, a lens surface of the first optical system closest to the reduction side has a concave shape, and Conditional Expressions (1) and (2) are satisfied, which are represented by

$$0.11 < D air / DAL < 0.25 \qquad ( 1 )$$

$$and$$

$$1 < DG 1 / DG 2 < 2.4 . \qquad ( 2 )$$

In a case where an air spacing on the optical axis between the first optical system and the second optical system is denoted by Dair. A distance on the optical axis from a lens surface of the first optical system closest to the magnification side to a lens surface of the second optical system closest to the reduction side is denoted by DAL. A distance on the optical axis from the lens surface of the first optical system closest to the magnification side to the lens surface of the first optical system closest to the reduction side is denoted by DG1. A distance on the optical axis from a lens surface of the second optical system closest to the magnification side to the lens surface of the second optical system closest to the reduction side is denoted by DG2. In a case where the imaging optical system is a variable magnification optical system, Dair, DAL, DG1, and DG2 are values at a wide-angle end.

It is preferable that a maximum half angle of view of the imaging optical system of the aspect is 45 degrees or more. In a case where the imaging optical system is a variable magnification optical system, the maximum half angle of view is a value at the wide-angle end.

It is preferable that the lens surface of the second optical system closest to the magnification side has a concave shape.

It may be configured that the imaging optical system of the aspect is a zoom lens in which a moving lens group that moves during a change in magnification is included in the second optical system.

It may be configured that the second optical system includes, in consecutive order from the magnification side to the reduction side along the optical path, a first moving lens group having positive refractive power, a second moving lens group having refractive power, and a third moving lens group having refractive power, and during a change in the magnification, a spacing between the first moving lens group and the second moving lens group changes, and a spacing between the second moving lens group and the third moving lens group changes.

It may be configured that each of the second moving lens group and the third moving lens group has positive refractive power.

In a case where a focal length of the first moving lens group is denoted by fz1, and a focal length of the second moving lens group is denoted by fz2, it is preferable that the imaging optical system of the aspect satisfies Conditional Expression (3) represented by

$$0 < \vert fz 1 / fz 2 \vert < 1. \qquad ( 3 )$$

In a case where a focal length of the first moving lens group is denoted by fz1, and a focal length of the third moving lens group is denoted by fz3, it is preferable that the imaging optical system of the aspect satisfies Conditional Expression (4) represented by

$$0 < \vert fz 1 / fz 3 \vert < 1.5 . \qquad ( 4 )$$

It may be configured that a lens closest to the magnification side in the second optical system remains stationary with respect to the reduction-side imaging plane during a change in the magnification.

It may be configured that the second optical system includes, closest to the magnification side, an optical path bending member that bends the optical path.

In a case where a focal length of the first optical system is denoted by f1, a focal length of the imaging optical system is denoted by f, and in a case where the imaging optical system is a variable magnification optical system, f1 and f are values at the wide-angle end, it is preferable that the imaging optical system of the aspect satisfies Conditional Expression (5) represented by

$$0.7 < \vert f 1 / f \vert < 1.4 . \qquad ( 5 )$$

In a case where a focal length of the first optical system is denoted by f1, a focal length of the second optical system is denoted by f2, and in a case where the imaging optical system is a variable magnification optical system, f1 and f2 are values at the wide-angle end, it is preferable that the imaging optical system of the aspect satisfies Conditional Expression (6) represented by

$$0.01 < \vert f 1 / f 2 \vert < 0.25 . \qquad ( 6 )$$

It is preferable that the second optical system includes at least one positive lens, and in a case where a refractive index of the positive lens of the second optical system at a d line is denoted by N2p, an Abbe number of the positive lens of the second optical system at the d line is denoted by v2p, a temperature coefficient, at a temperature of 20° C., of the refractive index of the positive lens of the second optical system at the d line is denoted by (dN2p/dT)×10⁻⁶, and a unit of dN2p/dT is ° C.⁻¹, the second optical system includes at least one positive lens satisfying Conditional Expressions (7), (8), and (9) represented by

$$1.4 < N 2 p < 1.55 , \qquad ( 7 )$$

$$66 < v 2 p < 100 , and \qquad ( 8 )$$

$$0 < dN 2 p / dT < 10. \qquad ( 9 )$$

It may be configured that the first optical system consists of, in order from the magnification side to the reduction side along the optical path, a first F group and a first R group that are separated by a maximum air spacing on the optical axis in the first optical system, and the intermediate image is formed in the first R group. In this configuration, in a case where a focal length of the first F group is denoted by f1F, a focal length of the first R group is denoted by f1R, and in a case where the imaging optical system is a variable magnification optical system, f1F and f1R are values at the wide-angle end, it is preferable that the imaging optical system of the aspect satisfies Conditional Expression (10) represented by

$$0.25 < f 1 F / f 1 R < 0.75 . \qquad ( 10 )$$

It may be configured that the first R group consists of, in order from the magnification side to the reduction side along the optical path, a first Ra sub-group having refractive power, and a first Rb sub-group having negative refractive power, and the intermediate image is formed between the first Ra sub-group and the first Rb sub-group. In this configuration, in a case where a focal length of the first Ra sub-group is denoted by f1Ra, a focal length of the first Rb sub-group is denoted by f1Rb, and in a case where the imaging optical system is a variable magnification optical system, f1Ra and f1Rb are values at the wide-angle end, it is preferable that the imaging optical system of the aspect satisfies Conditional Expression (11) represented by

$$- 1.5 < f 1 Ra / f 1 Rb < - 0.5 . \qquad ( 11 )$$

It may be configured that the first Rb sub-group consists of one or two lenses.

It may be configured that a focus group that moves during focusing is disposed in only the first F group. In this configuration, in a case where a ray emitted at a bisector of an angle formed by an upper ray and a lower ray among rays emitted from a maximum image height of the reduction-side imaging plane to the magnification side is defined as an intermediate ray, it is preferable that the intermediate ray intersects with the optical axis in the focus group.

It may be configured that the focus group consists of two groups that move by changing mutual spacings during focusing. In this configuration, in focusing from a short range to a long range, it is preferable that a group on the magnification side out of the two groups moves to the reduction side.

According to another aspect of the present disclosure, there is provided a projection type display device comprising the imaging optical system of the aspect.

According to still another aspect of the present disclosure, there is provided an imaging apparatus comprising the imaging optical system of the aspect.

The terms “consist of” and “consisting of” in the present specification are intended to include, in addition to illustrated constituents, a lens substantially not having refractive power, an optical element, other than a lens, such as a stop, a mask, a filter, a cover glass, a plane mirror, and a prism, and a mechanism part such as a lens flange, a lens barrel, an imaging element, and a camera shake correction mechanism.

A “group having positive refractive power” and an expression “a group has positive refractive power” in the present specification mean that the whole group has positive refractive power. Similarly, a “group having negative refractive power” and an expression “a group has negative refractive power” mean that the whole group has negative refractive power. A “group” in the present specification is not limited to being configured to consist of a plurality of lenses, and may be configured to consist of only one lens.

The number of lenses described above is the number of lenses as constituents. For example, the number of lenses in a cemented lens in which a plurality of single lenses made of different materials are cemented is represented by the number of single lenses constituting the cemented lens. However, a compound aspherical lens (a lens in which a lens (for example, a spherical lens) and a film having an aspherical shape formed on the lens are configured to be integrated with each other, and that functions as one aspherical lens as a whole) is not regarded as a cemented lens and is treated as one lens. Unless otherwise specified, a sign of refractive power and a surface shape in a paraxial region are used with respect to a lens including an aspherical surface.

Unless otherwise specified, a “distance on the optical axis” used in the conditional expressions is a geometrical distance. A “focal length” used in the conditional expressions is a paraxial focal length. Values used in the conditional expressions are values at a d line. In a case where the imaging optical system is a variable magnification optical system, the values used in the conditional expressions are values at the wide-angle end, unless otherwise specified.

A “d line”, a “C line”, and an “F line” according to the present specification are bright lines. A wavelength of the d line is 587.56 nanometers (nm). A wavelength of the C line is 656.27 nanometers (nm). A wavelength of the F line is 486.13 nanometers (nm).

According to the present disclosure, an imaging optical system that is an optical system forming an intermediate image, has an appropriate air spacing, is reduced in size, and maintains favorable optical performance, a projection type display device comprising the imaging optical system, and an imaging apparatus comprising the imaging optical system can be provided.

### BRIEF DESCRIPTION OF THE DRAWINGS

FIG. 1 is a cross-sectional view corresponding to an imaging optical system of Example 1, showing a configuration and luminous fluxes of an imaging optical system according to an embodiment.

FIG. 2 is a diagram for describing symbols of conditional expressions.

FIG. 3 is a cross-sectional view showing a configuration and luminous fluxes of a modification example of the imaging optical system of Example 1.

FIG. 4 is each aberration diagram of the imaging optical system of Example 1.

FIG. 5 is a cross-sectional view showing a configuration and luminous fluxes of an imaging optical system of Example 2.

FIG. 6 is a cross-sectional view showing a configuration and luminous fluxes of a modification example of the imaging optical system of Example 2.

FIG. 7 is each aberration diagram of the imaging optical system of Example 2.

FIG. 8 is a cross-sectional view showing a configuration and luminous fluxes of an imaging optical system of Example 3.

FIG. 9 is a cross-sectional view showing a configuration and luminous fluxes of a modification example of the imaging optical system of Example 3.

FIG. 10 is each aberration diagram of the imaging optical system of Example 3.

FIG. 11 is a cross-sectional view showing a configuration and luminous fluxes of an imaging optical system of Example 4.

FIG. 12 is a cross-sectional view showing a configuration and luminous fluxes of a modification example of the imaging optical system of Example 4.

FIG. 13 is each aberration diagram of the imaging optical system of Example 4.

FIG. 14 is a cross-sectional view showing a configuration and luminous fluxes of an imaging optical system of Example 5.

FIG. 15 is a cross-sectional view showing a configuration and luminous fluxes of a modification example of the imaging optical system of Example 5.

FIG. 16 is each aberration diagram of the imaging optical system of Example 5.

FIG. 17 is a cross-sectional view showing a configuration and luminous fluxes of an imaging optical system of Example 6.

FIG. 18 is a cross-sectional view showing a configuration and luminous fluxes of a modification example of the imaging optical system of Example 6.

FIG. 19 is each aberration diagram of the imaging optical system of Example 6.

FIG. 20 is a cross-sectional view showing a configuration and luminous fluxes of an imaging optical system of Example 7.

FIG. 21 is a cross-sectional view showing a configuration and luminous fluxes of a modification example of the imaging optical system of Example 7.

FIG. 22 is each aberration diagram of the imaging optical system of Example 7.

FIG. 23 is a schematic configuration diagram of a projection type display device according to an embodiment.

FIG. 24 is a schematic configuration diagram of a projection type display device according to another embodiment.

FIG. 25 is a schematic configuration diagram of a projection type display device according to still another embodiment.

FIG. 26 is a perspective view of an imaging apparatus according to an embodiment on a front surface side.

FIG. 27 is a perspective view of the imaging apparatus according to an embodiment on a rear surface side.

### DETAILED DESCRIPTION

Hereinafter, embodiments of the present disclosure will be described with reference to the drawings.

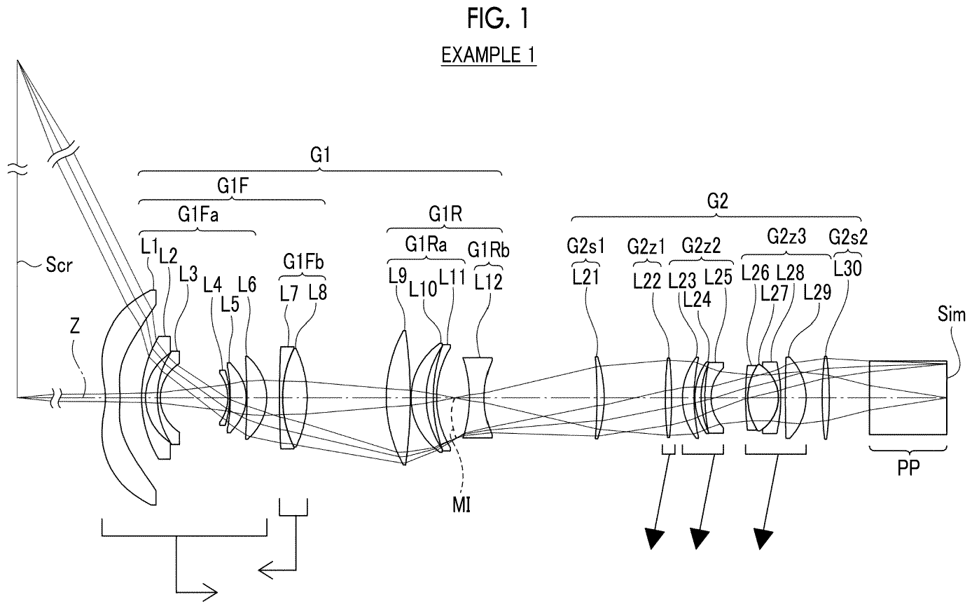

FIG. 1 shows a cross-sectional view of a configuration and luminous fluxes of an imaging optical system according to an embodiment of the present disclosure at a wide-angle end. FIG. 1 shows an on-axis luminous flux and a luminous flux at a maximum image height as luminous fluxes. The example shown in FIG. 1 corresponds to an imaging optical system of Example 1 described later. In FIG. 1, a left side is a magnification side, and a right side is a reduction side.

The imaging optical system of the present disclosure can be a projection optical system that is mounted on a projection type display device and forms an image to be projected to a screen, or can be an imaging optical system that is mounted on an imaging apparatus and forms an image of an object. The following description will be provided on an assumption that the imaging optical system is used as a projection optical system. In addition, in the following description, the “imaging optical system of the present disclosure” may be simply referred to as the “imaging optical system” to avoid redundant description.

FIG. 1 shows an example in which an optical member PP and an image display surface Sim of a light valve are disposed on the reduction side of the imaging optical system on an assumption that the imaging optical system is mounted on a projection type display device. The optical member PP is a member that is assumed to be a filter, a cover glass, a color-combining prism, and the like. The optical member PP does not have refractive power, and a configuration without the optical member PP can also be adopted. The light valve outputs an optical image, and the optical image is displayed on the image display surface Sim as an image.

In the projection type display device, luminous fluxes to which image information is assigned on the image display surface Sim are incident on the imaging optical system through the optical member PP, and are projected to a screen Scr via the imaging optical system. In this case, the image display surface Sim corresponds to a reduction-side imaging plane, and the screen Scr corresponds to a magnification-side imaging plane. The imaging optical system of the present disclosure is an imaging optical system in which a reduction-side imaging plane and a magnification-side imaging plane are conjugate to each other. In the present specification, the “screen Scr” means an object to which a projection image formed by the imaging optical system is projected. The screen Scr may be not only a dedicated screen but also a wall surface, a floor surface, and a ceiling of a room, an outer wall of a building, and the like. FIG. 1 conceptually shows the screen Scr, and a size of the screen Scr in FIG. 1 is not necessarily accurate.

In the description of the present specification, the “magnification side” means a screen side on an optical path, and the “reduction side” means an image display surface side on the optical path. In the present specification, the “magnification side” and the “reduction side” are determined along the optical path, and this point also applies to an imaging optical system in which a bending optical path is formed. The term “closest to the magnification side” means being closest to the magnification side in order of arrangement on the optical path, and does not mean being closest to the screen Scr in distance terms. The term “adjacent” related to disposition of constituents means being adjacent to each other in order of arrangement on the optical path. Hereinafter, the term “in order from the magnification side to the reduction side along the optical path” may be referred to as “in order from the magnification side to the reduction side” to avoid redundant description.

The imaging optical system of the present disclosure forms, in the imaging optical system, an intermediate image MI at a position conjugate to the magnification-side imaging plane. A configuration of forming the intermediate image MI in the imaging optical system can implement a wide-angle optical system while securing a long back focus. In FIG. 1, only a part of the intermediate image MI below an optical axis Z is schematically shown by a dotted line. The intermediate image MI in FIG. 1 shows a position in an optical axis direction and does not necessarily show an accurate shape.

The imaging optical system of the present disclosure consists of, in order from the magnification side to the reduction side along the optical path, a first optical system G1 and a second optical system G2. The first optical system G1 and the second optical system G2 are separated by a maximum air spacing among air spacings between lenses on the optical axis on the reduction side with respect to the intermediate image MI. That is, the intermediate image MI is formed in the first optical system G1.

For example, the first optical system G1 in FIG. 1 consists of, in order from the magnification side to the reduction side, twelve lenses including lenses L1 to L12, and the second optical system G2 consists of, in order from the magnification side to the reduction side, ten lenses including lenses L21 to L30. In the example in FIG. 1, the intermediate image MI is formed between the lens L11 and the lens L12, and an air spacing between the lens L12 and the lens L21 corresponds to the maximum air spacing.

The first optical system G1 includes a plurality of lenses disposed on the magnification side with respect to the intermediate image MI, and at least one lens disposed on the reduction side with respect to the intermediate image MI. Among lens surfaces included in the first optical system G1, a lens surface adjacent to the intermediate image MI on the magnification side is configured to have a concave shape, and a lens surface adjacent to the intermediate image MI on the reduction side is configured to have a concave shape. By providing the lens surface adjacent to the intermediate image MI with a concave shape, an advantage in correcting field curvature is provided.

A lens surface of the first optical system G1 closest to the reduction side is configured to have a concave shape. This configuration provides an advantage in reducing an increase in diameters of effective diameters of a lens surface adjacent to the maximum air spacing on the magnification side and a lens surface adjacent to the maximum air spacing on the reduction side.

The first optical system G1 may be configured to consist of, in order from the magnification side to the reduction side along the optical path, a first F group GIF and a first R group G1R that are separated by the maximum air spacing on the optical axis in the first optical system G1. In this case, the intermediate image MI may be configured to be formed in the first R group G1R.

More specifically, the first R group G1R may be configured to consist of, in order from the magnification side to the reduction side along the optical path, a first Ra sub-group G1Ra having refractive power, and a first Rb sub-group G1Rb having negative refractive power. The intermediate image MI may be configured to be formed between the first Ra sub-group G1Ra and the first Rb sub-group G1Rb. For example, in the example in FIG. 1, the first Ra sub-group G1Ra consists of the lenses L9 to L11. The first Rb sub-group G1Rb consists of the lens L12. The intermediate image MI is formed between the lens L11 and the lens L12.

It is preferable that the first Ra sub-group G1Ra includes a biconvex lens closest to the magnification side. In this case, the first Ra sub-group G1Ra is used as a field lens group, and reduction in a diameter of the intermediate image MI is facilitated.

It is preferable that the first Ra sub-group G1Ra includes a meniscus lens closest to the reduction side. In this case, light from the intermediate image MI can be gently bent. Thus, an advantage in aberration correction is provided.

The first Rb sub-group G1Rb may be configured to consist of one or two lenses. By reducing the number of lenses of the first Rb sub-group G1Rb in such a manner, an advantage in reduction in size is provided, and an advantage in reduction in cost is also provided.

The imaging optical system may be configured to include a focus group that moves during focusing, and the focus group may be configured to be disposed in only the first F group GIF. Even in the first optical system G1, it is preferable that the focus group is disposed in the first F group GIF which is relatively far from the intermediate image MI. In addition, as will be described later, in a case where the imaging optical system is a variable magnification optical system, it is preferable that a lens group that moves during a change in magnification is disposed in the second optical system G2 instead of the first optical system G1. Thus, in a case where the focus group is disposed in the first optical system G1 that remains stationary during a change in the magnification, an operation in which a change in the magnification is separated from focusing can be performed.

The focus group may be configured to consist of two groups that move by changing a mutual spacing during focusing. In this case, an advantage in reducing changes in aberration during focusing is provided. In a case where the focus group consists of the two groups, a group on the magnification side out of the two groups may be configured to move to the reduction side during focusing from a short range to a long range. In this case, an advantageous configuration is obtained from an expression of a conjugate relationship of a lens system between the intermediate image MI and the magnification-side imaging plane. Thus, focusing can be performed without increasing a total length of the imaging optical system. In addition, in a case where the focus group consists of the two groups, a group on the reduction side out of the two groups may be configured to move to the magnification side during focusing from the short range to the long range. Even in this case, focusing can be performed without increasing the total length of the imaging optical system. The term “during focusing from the short range to the long range” in the present specification refers to a change in a distance between the imaging optical system and the screen Scr from the short range to the long range.

In the example in FIG. 1, the first F group GIF is the focus group. The first F group GIF consists of, in order from the magnification side to the reduction side, a first Fa sub-group G1Fa having refractive power, and a first Fb sub-group G1Fb having refractive power. For example, in the example in FIG. 1, the first Fa sub-group G1Fa consists of the lenses L1 to L6, and the first Fb sub-group G1Fb consists of the lenses L7 and L8. During focusing from the short range to the long range, the first Fa sub-group G1Fa moves to the reduction side, and the first Fb sub-group G1Fb moves to the magnification side. In FIG. 1, directions of movement during focusing from the short range to the long range are shown by arrows below the first Fa sub-group G1Fa and the first Fb sub-group G1Fb.

In a configuration in which the focus group is disposed in only the first F group GIF, in a case where a ray emitted at a bisector of an angle formed by an upper ray and a lower ray among rays emitted from the maximum image height of the reduction-side imaging plane to the magnification side is referred to as an intermediate ray, it is preferable that the intermediate ray intersects with the optical axis Z in the focus group. In this case, an advantage in maintaining resolution during focusing is provided.

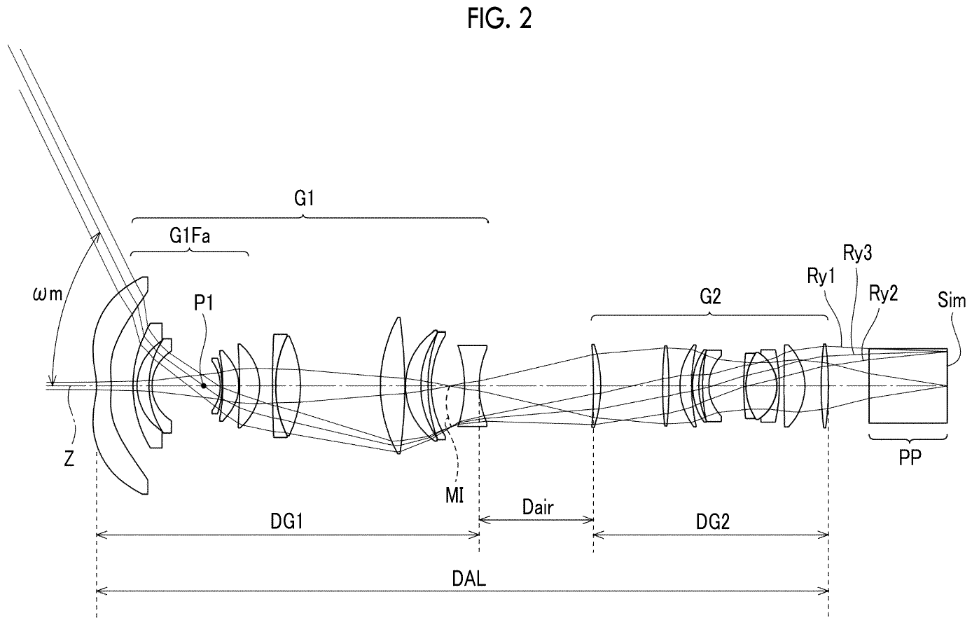

For example, FIG. 2 shows a cross-sectional view of a configuration of the imaging optical system in FIG. 1 at the wide-angle end, and shows an upper ray Ry1, a lower ray Ry2, and an intermediate ray Ry3 emitted from the maximum image height of the reduction-side imaging plane to the magnification side. The intermediate ray Ry3 is a ray emitted at a bisector of an angle formed by the upper ray Ry1 and the lower ray Ry2. That is, an angle formed by the upper ray Ry1 and the intermediate ray Ry3 is equal to an angle formed by the lower ray Ry2 and the intermediate ray Ry3 near the reduction-side imaging plane. The upper ray Ry1 is a ray farthest from the optical axis Z in a cross section including the optical axis Z among rays incident on the imaging optical system from the maximum image height of the reduction-side imaging plane, and the lower ray Ry2 is a ray closest to the optical axis Z in the same cross section including the optical axis Z among the rays incident on the imaging optical system from the maximum image height of the reduction-side imaging plane. The terms “far from the optical axis Z” and “close to the optical axis Z” are determined near the reduction-side imaging plane. FIG. 2 shows an intersection P1 between the intermediate ray Ry3 and the optical axis Z. In the example in FIG. 2, the intersection P1 is positioned in the first Fa sub-group G1Fa.

The imaging optical system of the present disclosure is applicable to any of an optical system in which light travels from the reduction side to the magnification side, or an optical system in which light travels from the magnification side to the reduction side. Accordingly, the “intermediate ray that is emitted at a bisector of an angle formed by an upper ray and a lower ray among rays emitted from the maximum image height of the reduction-side imaging plane to the magnification side” is synonymous with an “intermediate ray that is a ray incident at a bisector of an angle formed by an upper ray and a lower ray among rays incident from the magnification side to the maximum image height of the reduction-side imaging plane”.

It is preferable that the first F group GIF includes one or more aspherical lenses. An aspherical lens is advantageous for aberration correction and the like, compared to a case where a spherical lens is used. In particular, by using an aspherical lens in the first F group GIF in which rays at each angle of view are dispersed compared to those in other groups, aberration correction can be effectively performed. Thus, an advantage in reducing the number of lenses is provided, and this results in an advantage in reduction in size.

The first F group GIF may be configured to include only two aspherical lenses. In this case, a cost can be reduced while providing a configuration that is advantageous for aberration correction and reduction in size.

A lens closest to the magnification side in the first optical system G1 may be configured to be an aspherical lens, and a lens surface of the first optical system G1 closest to the magnification side may be configured to have an aspherical shape that has a concave shape facing the magnification side in a paraxial region and includes a region in which negative refractive power weakens from the optical axis Z to an edge part. In this case, an advantage in obtaining a wide angle of view while reducing distortion is provided.

The second optical system G2 includes a plurality of lenses. It is preferable that a lens surface of the second optical system G2 closest to the magnification side has a concave shape. In this case, an increase in a diameter between the first optical system G1 and the second optical system G2 can be prevented.

The imaging optical system of the present disclosure may be a fixed focal point optical system or a variable magnification optical system. In a case where a fixed focal point optical system is used, an advantage in reducing a size of the whole apparatus can be provided. In a case where a variable magnification optical system is used, an optical system having good general-purpose properties can be obtained. A zoom lens or a varifocal lens may be used as a variable magnification optical system. In a case where a zoom lens is used, an optical system with high convenience of use can be obtained.

In a case where the imaging optical system of the present disclosure is a zoom lens, the second optical system G2, for example, may be configured to include a moving lens group that moves during a change in the magnification. A configuration in which the moving lens group is included in the second optical system G2 instead of the first optical system G1 that is a wide-angle system can reduce changes in field curvature and distortion during a change in the magnification.

The second optical system G2 may be configured to include, in consecutive order from the magnification side to the reduction side along the optical path, a first moving lens group G2z1 having positive refractive power, a second moving lens group G2z2 having refractive power, and a third moving lens group G2z3 having refractive power. In this case, a spacing between the first moving lens group G2z1 and the second moving lens group G2z2 and a spacing between the second moving lens group G2z2 and the third moving lens group G2z3 are configured to change during a change in the magnification. By configuring the second optical system G2 to include the three moving lens groups, a relatively high zoom ratio can be implemented with three groups which are a relatively small number of moving lens groups.

In a case where the second optical system G2 includes the three moving lens groups, the second moving lens group G2z2 and the third moving lens group G2z3 may be configured to be lens groups, each of which has positive refractive power. In this case, refractive power of the first moving lens group G2z1 can be reduced. Thus, an advantage in aberration correction during a change in the magnification is provided.

In a case where the second optical system G2 includes a plurality of moving lens groups that move by changing spacings with respect to adjacent groups during a change in the magnification, a lens closest to the magnification side in the second optical system G2 may be configured to remain stationary with respect to the reduction-side imaging plane during a change in the magnification. In this case, an advantage in simplifying a moving mechanism is provided.

For example, the second optical system G2 in FIG. 1 is configured as follows. The second optical system G2 consists of, in order from the magnification side to the reduction side, a first stationary lens group G2s1, the first moving lens group G2z1, the second moving lens group G2z2, the third moving lens group G2z3, and a second stationary lens group G2s2. The first stationary lens group G2s1 consists of the lens L21. The first moving lens group G2z1 consists of the lens L22. The second moving lens group G2z2 consists of, in order from the magnification side to the reduction side, the lenses L23 to L25. The third moving lens group G2z3 consists of, in order from the magnification side to the reduction side, the lenses L26 to L29. The second stationary lens group G2s2 consists of the lens L30.

In the example in FIG. 1, during a change in the magnification, the first stationary lens group G2s1 and the second stationary lens group G2s2 remain stationary with respect to the reduction-side imaging plane, and the first moving lens group G2z1, the second moving lens group G2z2, and the third moving lens group G2z3 move along the optical axis Z by changing spacings with respect to adjacent lens groups. In FIG. 1, for lens groups that move during a change in the magnification, a schematic moving trajectory of each lens group during a change in the magnification from the wide-angle end to a telephoto end is shown by an arrow below each lens group.

In the present specification, a group of which a spacing with respect to an adjacent group in the optical axis direction changes during a change in the magnification in the second optical system G2 is defined as one lens group. That is, a “lens group” is a part of the second optical system G2 as a constituent and includes at least one lens divided by an air spacing that changes during a change in the magnification. During a change in the magnification, a spacing between adjacent lenses does not change in one lens group. During a change in the magnification, each lens group moves or remains stationary in lens group units. A “lens group” may include a constituent, other than a lens, not having power, such as, for example, an aperture stop St and/or a plane mirror.

The second optical system G2 may be configured to include, closest to the magnification side, an optical path bending member that bends the optical path. In this case, a length in a direction perpendicular to the reduction-side imaging plane can be reduced. Thus, an advantage in reduction in size is provided, and installation properties can be improved. For example, a mirror and a prism having a reflecting surface can be used as the optical path bending member.

It is preferable that diameters of all lenses included in the second optical system G2 are smaller than Dair. In this case, an advantage in reduction in size is provided. In addition, in a case where the optical path bending member is included, a size of the optical path bending member can be reduced by setting the diameters of all lenses included in the second optical system G2 to be smaller than Dair.

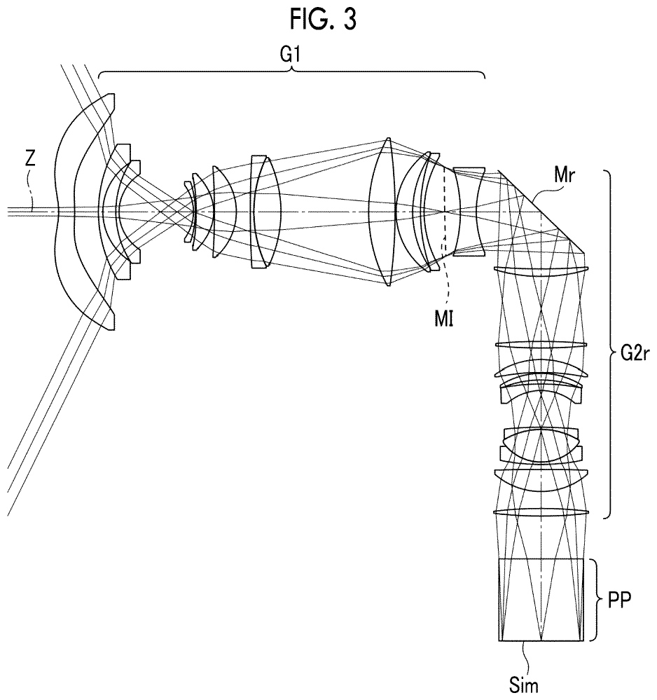

FIG. 3 shows an example of the imaging optical system including the optical path bending member as a modification example of the imaging optical system in FIG. 1. The imaging optical system in FIG. 3 consists of, in order from the magnification side to the reduction side along the optical path, the first optical system G1 and a second optical system G2r. The imaging optical system in FIG. 3 is different from the imaging optical system in FIG. 1 in that a mirror Mr is disposed closest to the magnification side in the second optical system G2r, and the mirror Mr bends the optical path. Configurations of other lenses are the same as those in the example in FIG. 1. The mirror Mr is an example of an optical path bending member of the disclosed technology. FIG. 3 shows a configuration at the wide-angle end, and some reference numerals are not shown to avoid complication of illustration.

It is preferable that a maximum half angle of view of the imaging optical system of the present disclosure is 45 degrees or more. In this case, an optical system that has a short focal point while having a wide angle of view can be obtained. Thus, in a case where the imaging optical system is configured as a projection optical system, a large image can be projected from a location close to the screen Scr. In a case where the imaging optical system is a variable magnification optical system, the maximum half angle of view is a value at the wide-angle end. For example, FIG. 2 shows a maximum half angle of view ωm.

Next, preferable configurations of conditional expressions of the imaging optical system of the present disclosure will be described. In order to avoid redundant description, the same symbols will be used for the same definitions so as not to repeat description of the symbols in the following description related to the conditional expressions.

It is preferable that the imaging optical system satisfies Conditional Expression (1). An air spacing on the optical axis between the first optical system G1 and the second optical system G2 is denoted by Dair. A distance on the optical axis from the lens surface of the first optical system G1 closest to the magnification side to a lens surface of the second optical system G2 closest to the reduction side is denoted by DAL. In a case where the imaging optical system is a variable magnification optical system, Dair and DAL are values at the wide-angle end. For example, FIG. 2 shows the air spacing Dair and the distance DAL. By ensuring that a corresponding value of Conditional Expression (1) is not less than or equal to its lower limit value, a distance from the lens surface of the second optical system G2 closest to the magnification side to the intermediate image MI can be further increased. Thus, sensitivity to deterioration of resolution caused by eccentricity and/or falling of a member included in the second optical system G2 can be reduced. By ensuring that the corresponding value of Conditional Expression (1) is not greater than or equal to its upper limit value, an excessive increase in the air spacing between the first optical system G1 and the second optical system G2 is prevented. Thus, an increase in a diameter of a lens near the intermediate image in the first optical system G1 can be reduced.

$$0.11 < Dair / DAL < 0.25 \qquad ( 1 )$$

To obtain more favorable characteristics, the lower limit value of Conditional Expression (1) is more preferably 0.12, further preferably 0.13, and still more preferably 0.14. To obtain more favorable characteristics, the upper limit value of Conditional Expression (1) is more preferably 0.22, further preferably 0.2, and still more preferably 0.18. For example, the imaging optical system more preferably satisfies Conditional Expression (1-1), further preferably satisfies Conditional Expression (1-2), and still more preferably satisfies Conditional Expression (1-3).

$$0.12 < Dair / DAL < 0.22 \qquad ( 1 - 1 )$$

$$0.13 < Dair / DAL < 0.2 \qquad ( 1 - 2 )$$

$$0.14 < Dair / DAL < 0.18 \qquad ( 1 - 3 )$$

It is preferable that the imaging optical system satisfies Conditional Expression (2). A distance on the optical axis from the lens surface of the first optical system G1 closest to the magnification side to the lens surface of the first optical system G1 closest to the reduction side is denoted by DG1. A distance on the optical axis from the lens surface of the second optical system G2 closest to the magnification side to the lens surface of the second optical system G2 closest to the reduction side is denoted by DG2. In a case where the imaging optical system is a variable magnification optical system, DG1 and DG2 are values at the wide-angle end. For example, FIG. 2 shows the distance DG1 and the distance DG2. By ensuring that a corresponding value of Conditional Expression (2) is not less than or equal to its lower limit value, a length of the second optical system G2 can be further reduced. Thus, an advantage in reducing the total length of the imaging optical system is provided. By ensuring that the corresponding value of Conditional Expression (2) is not greater than or equal to its upper limit value, a length of the first optical system G1 in which the intermediate image MI is formed can be further reduced. Thus, an advantage in reducing the total length of the imaging optical system is provided.

$$1 < DG 1 / DG 2 < 2.4 \qquad ( 2 )$$

To obtain more favorable characteristics, the lower limit value of Conditional Expression (2) is more preferably 1.1, further preferably 1.2, and still more preferably 1.4. To obtain more favorable characteristics, the upper limit value of Conditional Expression (2) is more preferably 2, further preferably 1.9, and still more preferably 1.8. For example, the imaging optical system more preferably satisfies Conditional Expression (2-1), further preferably satisfies Conditional Expression (2-2), and still more preferably satisfies Conditional Expression (2-3).

$$1.1 < DG 1 / DG 2 < 2 \qquad ( 2 - 1 )$$

$$1.2 < DG 1 / DG 2 < 1.9 \qquad ( 2 - 2 )$$

$$1.4 < DG 1 / DG 2 < 1.8 \qquad ( 2 - 3 )$$

In a configuration in which the second optical system G2 includes the above three moving lens groups, it is preferable that the imaging optical system satisfies Conditional Expression (3). A focal length of the first moving lens group G2z1 is denoted by fz1. A focal length of the second moving lens group G2z2 is denoted by fz2. Since |fz1/fz2| is an absolute value, 0<|fz1/fz2| is satisfied for a lower limit of Conditional Expression (3). By ensuring that a corresponding value of Conditional Expression (3) is not greater than or equal to its upper limit value, the first moving lens group G2z1 that has a relatively large moving amount during a change in the magnification can have stronger refractive power than the second moving lens group G2z2. Thus, the magnification can be effectively changed while maintaining aberration correction.

$$0 < \vert fz 1 / fz 2 \vert < 1 \qquad ( 3 )$$

To obtain more favorable characteristics, the upper limit value of Conditional Expression (3) is more preferably 0.8, further preferably 0.6, and still more preferably 0.4. For example, the imaging optical system more preferably satisfies Conditional Expression (3-1), further preferably satisfies Conditional Expression (3-2), and still more preferably satisfies Conditional Expression (3-3).

$$0 < \vert fz 1 / fz 2 \vert < 0.8 \qquad ( 3 - 1 )$$

$$0 < \vert fz 1 / fz 2 \vert < 0.6 \qquad ( 3 - 2 )$$

$$0 < \vert fz 1 / fz 2 \vert < 0.4 \qquad ( 3 - 3 )$$

In a configuration in which the second optical system G2 includes the above three moving lens groups, it is preferable that the imaging optical system satisfies Conditional Expression (4). A focal length of the third moving lens group G2z3 is denoted by fz3. Since |fz1/fz3| is an absolute value, 0<|fz1/fz3| is satisfied for a lower limit of Conditional Expression (4). By ensuring that a corresponding value of Conditional Expression (4) is not greater than or equal to its upper limit value, the first moving lens group G2z1 that has a relatively large moving amount during a change in the magnification can have relatively strong refractive power. Thus, an advantage in effectively a change in the magnification while maintaining favorable aberration correction is provided.

$$0 < \vert fz 1 / fz 3 \vert < 1.5 \qquad ( 4 )$$

To obtain more favorable characteristics, a lower limit value of Conditional Expression (4) is more preferably 0.2. By ensuring that the corresponding value of Conditional Expression (4) is not less than or equal to 0.2, the refractive power of the third moving lens group G2z3 can be secured. Thus, an advantage in favorable aberration correction is provided. To obtain more favorable characteristics, the lower limit value of Conditional Expression (4) is further preferably 0.4. To obtain more favorable characteristics, the upper limit value of Conditional Expression (4) is more preferably 1.2, further preferably 1, and still more preferably 0.8. For example, the imaging optical system more preferably satisfies Conditional Expression (4-1), further preferably satisfies Conditional Expression (4-2), and still more preferably satisfies Conditional Expression (4-3).

$$0 < \vert fz 1 / fz 3 \vert < 1.2 \qquad ( 4 - 1 )$$

$$0.2 < \vert fz 1 / fz 3 \vert < 1 \qquad ( 4 - 2 )$$

$$0.4 < \vert fz 1 / fz 3 \vert < 0.8 \qquad ( 4 - 3 )$$

It is preferable that the imaging optical system satisfies Conditional Expression (5). A focal length of the first optical system G1 is denoted by f1. A focal length of the imaging optical system is denoted by f. In a case where the imaging optical system is a variable magnification optical system, f1 and f are values at the wide-angle end. By ensuring that a corresponding value of Conditional Expression (5) is not less than or equal to its lower limit value, a size of the intermediate image MI can be secured. Thus, an advantage in securing optical performance is provided. By ensuring that the corresponding value of Conditional Expression (5) is not greater than or equal to its upper limit value, the size of the intermediate image MI can be reduced. Thus, an advantage in reducing an increase in a diameter of a lens is provided.

$$0.7 < \vert f 1 / f \vert < 1.4 \qquad ( 5 )$$

To obtain more favorable characteristics, the lower limit value of Conditional Expression (5) is more preferably 0.75, further preferably 0.8, and still more preferably 0.9. To obtain more favorable characteristics, the upper limit value of Conditional Expression (5) is more preferably 1.3, further preferably 1.2, and still more preferably 1.1. For example, the imaging optical system more preferably satisfies Conditional Expression (5-1), further preferably satisfies Conditional Expression (5-2), and still more preferably satisfies Conditional Expression (5-3).

$$0.75 < \vert f 1 / f \vert < 1.3 \qquad ( 5 - 1 )$$

$$0.8 < \vert f 1 / f \vert < 1.2 \qquad ( 5 - 2 )$$

$$0.9 < \vert f 1 / f \vert < 1.1 \qquad ( 5 - 3 )$$

It is preferable that the imaging optical system satisfies Conditional Expression (6). A focal length of the second optical system G2 is denoted by f2. In a case where the imaging optical system is a variable magnification optical system, f2 is a value at the wide-angle end. By ensuring that a corresponding value of Conditional Expression (6) is not less than or equal to its lower limit value, the second optical system G2 can have refractive power. Thus, the second optical system G2 can be prevented from being an afocal system. In a case where the second optical system G2 is an afocal system, a diameter of a lens closest to the reduction side in the first optical system G1 increases, and the size of the intermediate image MI also increases. By ensuring that the corresponding value of Conditional Expression (6) is not greater than or equal to its upper limit value, the size of the intermediate image MI can be reduced. Thus, an advantage in reducing an increase in a diameter of a lens is provided.

$$0.01 < \vert f 1 / f 2 \vert < 0.25 \qquad ( 6 )$$

To obtain more favorable characteristics, the lower limit value of Conditional Expression (6) is more preferably 0.02, further preferably 0.03, and still more preferably 0.04. To obtain more favorable characteristics, the upper limit value of Conditional Expression (6) is more preferably 0.2, further preferably 0.15, and still more preferably 0.11. For example, the imaging optical system more preferably satisfies Conditional Expression (6-1), further preferably satisfies Conditional Expression (6-2), and still more preferably satisfies Conditional Expression (6-3).

$$0.02 < \vert f 1 / f 2 \vert < 0.2 \qquad ( 6 - 1 )$$

$$0.03 < \vert f 1 / f 2 \vert < 0.15 \qquad ( 6 - 2 )$$

$$0.04 < \vert f 1 / f 2 \vert < 0.11 \qquad ( 6 - 3 )$$

In a configuration in which the second optical system G2 includes at least one positive lens, it is preferable that the second optical system G2 includes at least one positive lens that satisfies Conditional Expressions (7), (8), and (9). A refractive index of the positive lens of the second optical system G2 at a d line is denoted by N2p. An Abbe number of the positive lens of the second optical system G2 at the d line is denoted by v2p. A temperature coefficient, at a temperature of 20° C., of the refractive index of the positive lens of the second optical system G2 at the d line is denoted by (dN2p/dT)×10⁻⁶, and the unit of dN2p/dT is ° C.⁻¹. In a case where the imaging optical system is mounted on a projection type display device as a projection optical system and performs projection, the reduction side of the imaging optical system is heated by a light source. By including at least one positive lens satisfying Conditional Expressions (7), (8), and (9) in the second optical system G2, an increase in the back focus during heating can be reduced.

$$1.4 < N 2 p < 1.55 \qquad ( 7 )$$

$$66 < v 2 p < 100 \qquad ( 8 )$$

$$0 < dN 2 p / dT < 10 \qquad ( 9 )$$

To obtain more favorable characteristics, the lower limit value of Conditional Expression (9) is more preferably 1.5 and further preferably 3.

In a configuration in which the first optical system G1 consists of the first F group GIF and the first R group G1R described above, and the intermediate image MI is formed in the first R group G1R, it is preferable that the imaging optical system satisfies Conditional Expression (10). A focal length of the first F group GIF is denoted by f1F. A focal length of the first R group G1R is denoted by f1R. In a case where the imaging optical system is a variable magnification optical system, f1F and f1R are values at the wide-angle end. By ensuring that a corresponding value of Conditional Expression (10) is not less than or equal to its lower limit value, refractive power of the first R group G1R that is a field lens group can be appropriately secured. Thus, an advantage in aberration correction is provided. By ensuring that the corresponding value of Conditional Expression (10) is not greater than or equal to its upper limit value, an excessive increase in the refractive power of the first R group G1R that is a field lens group is prevented. Thus, an advantage in reducing aberration is provided.

$$0.25 < f 1 F / f 1 R < 0.75 \qquad ( 10 )$$

To obtain more favorable characteristics, the lower limit value of Conditional Expression (10) is more preferably 0.27, further preferably 0.3, and still more preferably 0.33. To obtain more favorable characteristics, the upper limit value of Conditional Expression (10) is more preferably 0.7, further preferably 0.6, and still more preferably 0.5. For example, the imaging optical system more preferably satisfies Conditional Expression (10-1), further preferably satisfies Conditional Expression (10-2), and still more preferably satisfies Conditional Expression (10-3).

$$0.27 < f 1 F / f 1 R < 0.7 \qquad ( 10 - 1 )$$

$$0.3 < f 1 F / f 1 R < 0.6 \qquad ( 10 - 2 )$$

$$0.33 < f 1 F / f 1 R < 0.5 \qquad ( 10 - 3 )$$

In a configuration in which the first R group G1R consists of the first Ra sub-group G1Ra and the first Rb sub-group G1Rb described above, and the intermediate image MI is formed between the first Ra sub-group G1Ra and the first Rb sub-group G1Rb, it is preferable that the imaging optical system satisfies Conditional Expression (11). A focal length of the first Ra sub-group G1Ra is denoted by f1Ra. A focal length of the first Rb sub-group G1Rb is denoted by f1Rb. In a case where the imaging optical system is a variable magnification optical system, f1Ra and f1Rb are values at the wide-angle end. By ensuring that a corresponding value of Conditional Expression (11) is not less than or equal to its lower limit value, the negative refractive power of the first Rb sub-group G1Rb can be reduced. Thus, an excessive increase in the diameter of the intermediate image MI can be prevented. By ensuring that the corresponding value of Conditional Expression (11) is not greater than or equal to its upper limit value, the negative refractive power of the first Rb sub-group G1Rb can be secured. Thus, an advantage in correcting field curvature is provided.

$$- 1.5 < f 1 Ra / f 1 Rb < - 0.5 \qquad ( 11 )$$

To obtain more favorable characteristics, the lower limit value of Conditional Expression (11) is more preferably −1.3, further preferably −1.2, and still more preferably −1. To obtain more favorable characteristics, the upper limit value of Conditional Expression (11) is more preferably −0.6, further preferably −0.7, and still more preferably −0.8. For example, the imaging optical system more preferably satisfies Conditional Expression (11-1), further preferably satisfies Conditional Expression (11-2), and still more preferably satisfies Conditional Expression (11-3).

$$- 1.3 < f 1 Ra / f 1 Rb < - 0.6 \qquad ( 11 - 1 )$$

$$- 1.2 < f 1 Ra / f 1 Rb < - 0.7 \qquad ( 11 - 2 )$$

$$- 1 < f 1 Ra / f 1 Rb < - 0.8 \qquad ( 11 - 3 )$$

In a configuration in which the first Ra sub-group G1Ra includes at least one positive lens, it is preferable that a positive lens closest to the magnification side among positive lenses included in the first Ra sub-group G1Ra satisfies Conditional Expression (12). More preferably, all positive lenses included in the first Ra sub-group G1Ra satisfy Conditional Expression (12). A refractive index of the positive lens of the first Ra sub-group G1Ra at a d line is denoted by NRap. By ensuring that a corresponding value of Conditional Expression (12) is not less than or equal to its lower limit value, an advantage in correcting field curvature is provided. By ensuring that the corresponding value of Conditional Expression (12) is not greater than or equal to its upper limit value, suitable transmittance in a wavelength range of blue light can be secured.

$$1.8 < NRap < 2.35 \qquad ( 12 )$$

To obtain more favorable characteristics, the lower limit value of Conditional Expression (12) is more preferably 1.84 and further preferably 1.87.

In a configuration in which the first Ra sub-group G1Ra includes at least one positive lens, it is preferable that a positive lens closest to the magnification side among positive lenses included in the first Ra sub-group G1Ra satisfies Conditional Expression (13). More preferably, all positive lenses included in the first Ra sub-group G1Ra satisfy Conditional Expression (13). An Abbe number of the positive lens of the first Ra sub-group G1Ra at the d line is denoted by vRap. By ensuring that a corresponding value of Conditional Expression (13) is not less than or equal to its lower limit value, suitable transmittance in a wavelength range of blue light can be secured. By ensuring that the corresponding value of Conditional Expression (13) is not greater than or equal to its upper limit value, an advantage in correcting lateral chromatic aberration is provided.

$$15 < vRap < 30 \qquad ( 13 )$$

To obtain more favorable characteristics, the upper limit value of Conditional Expression (13) is more preferably 26 and further preferably 22.

More preferably, in a configuration in which the first Ra sub-group G1Ra includes at least one positive lens, a positive lens closest to the magnification side among positive lenses included in the first Ra sub-group G1Ra satisfies Conditional Expressions (12) and (13). Still more preferably, all positive lenses included in the first Ra sub-group G1Ra satisfy Conditional Expressions (12) and (13).

It is preferable that the imaging optical system satisfies Conditional Expression (14). A refractive index of a lens closest to the reduction side in the second optical system G2 at a d line is denoted by N2r. By ensuring that a corresponding value of Conditional Expression (14) is not less than or equal to its lower limit value, an advantage in correcting field curvature is provided. By ensuring that the corresponding value of Conditional Expression (14) is not greater than or equal to its upper limit value, suitable transmittance in a wavelength range of blue light can be secured.

$$1.8 < N 2 r < 2.35 \qquad ( 14 )$$

To obtain more favorable characteristics, the lower limit value of Conditional Expression (14) is more preferably 1.84 and further preferably 1.87.

It is preferable that the imaging optical system satisfies Conditional Expression (15). An Abbe number of the lens closest to the reduction side in the second optical system G2 at the d line is denoted by v2r. By ensuring that a corresponding value of Conditional Expression (15) is not less than or equal to its lower limit value, suitable transmittance in a wavelength range of blue light can be secured. By ensuring that the corresponding value of Conditional Expression (15) is not greater than or equal to its upper limit value, an advantage in correcting lateral chromatic aberration is provided.

$$15 < v 2 r < 30 \qquad ( 15 )$$

To obtain more favorable characteristics, the upper limit value of Conditional Expression (15) is more preferably 26 and further preferably 22.

More preferably, the imaging optical system satisfies Conditional Expressions (14) and (15).

The disclosed technology is not limited to the examples shown in FIGS. 1 to 3. Various modifications can be made without departing from the gist of the disclosed technology. For example, in the disclosed technology, the number of lenses included in the first optical system G1, the number of lens groups included in the second optical system G2, and the number of lenses included in each group may be different from those in the example in FIG. 1.

An angle at which the optical path bending member bends the optical path can be set to any angle and may be, for example, 90 degrees. By setting the bending angle to 90 degrees, a structure that is easily producible can be obtained. The term “90 degrees” includes error that is practically allowed in the technical field to which the disclosed technology belongs. The error may be, for example, +5 degrees.

The above preferable configurations and available configurations including the configurations related to the conditional expressions can be used in any combination thereof without contradiction, and are preferably appropriately selected and adopted in accordance with required specifications.

For example, according to a preferable aspect, the imaging optical system of the present disclosure is an imaging optical system that conjugates the reduction-side imaging plane and the magnification-side imaging plane each other, forms, in the imaging optical system, the intermediate image MI at a position conjugate to the magnification-side imaging plane, and consists of, in order from the magnification side to the reduction side along the optical path, the first optical system G1 and the second optical system G2, in which the first optical system G1 and the second optical system G2 are separated by the maximum air spacing among the air spacings between lenses on the optical axis on the reduction side with respect to the intermediate image MI, the first optical system G1 includes a lens surface having a concave shape adjacent to the intermediate image MI on the magnification side, and a lens surface having a concave shape adjacent to the intermediate image MI on the reduction side, the lens surface of the first optical system G1 closest to the reduction side has a concave shape, and Conditional Expressions (1) and (2) are satisfied.

Next, examples and modification examples of the imaging optical system of the present disclosure will be described with reference to the drawings. Reference numerals given in the cross-sectional views of the examples and the modification examples are independently used for each example and each modification example to avoid complication of description and illustration caused by an increasing number of digits of the reference numerals. Accordingly, a common reference numeral given in the drawings of different examples and modification examples does not necessarily indicate a common configuration.

### Example 1

FIG. 1 shows a cross-sectional view of a configuration and luminous fluxes of the imaging optical system of Example 1, and its illustration method and configuration are described above. Thus, some description will not be repeated. The imaging optical system of Example 1 is a zoom lens and consists of, in order from the magnification side to the reduction side, the first optical system G1 and the second optical system G2.

The first optical system G1 consists of, in order from the magnification side to the reduction side, the first F group GIF having positive refractive power, and the first R group G1R having positive refractive power. The first F group GIF consists of, in order from the magnification side to the reduction side, the first Fa sub-group G1Fa and the first Fb sub-group G1Fb. The first R group G1R consists of, in order from the magnification side to the reduction side, the first Ra sub-group G1Ra having positive refractive power, and the first Rb sub-group G1Rb having negative refractive power. During focusing from the short range to the long range, the first Fa sub-group G1Fa moves to the reduction side, and the first Fb sub-group G1Fb moves to the magnification side. The intermediate image MI is formed between the first Ra sub-group G1Ra and the first Rb sub-group G1Rb.

The second optical system G2 consists of, in order from the magnification side to the reduction side, the first stationary lens group G2s1 having positive refractive power, the first moving lens group G2z1 having positive refractive power, the second moving lens group G2z2 having positive refractive power, the third moving lens group G2z3 having positive refractive power, and the second stationary lens group G2s2 having positive refractive power.

For the imaging optical system of Example 1, Tables 1A and 1B show basic lens data, Table 2 shows specifications and variable surface spacings, and Table 3 shows aspherical coefficients. The basic lens data is divided and shown in two tables of Tables 1A and 1B to avoid one lengthy table. Table 1A shows the first optical system G1, and Table 1B shows the second optical system G2 and the optical member PP.

The table of the basic lens data is described as follows. A column of “Sn” shows surface numbers in a case where a surface closest to the magnification side is the first surface, and the number is increased one by one to the reduction side. A column of “R” shows a curvature radius of each surface. A column of “D” shows a surface spacing on the optical axis between each surface and a surface adjacent thereto on the reduction side. A column of “Nd” shows a refractive index of each optical element at a d line. A column of “vd” shows an Abbe number of each optical element at the d line.

In the table of the basic lens data, a sign of a curvature radius of a surface having a convex shape facing the magnification side is positive, and a sign of a curvature radius of a surface having a convex shape facing the reduction side is negative. In the table of basic lens data, a symbol DD[ ] is used for variable surface spacings during a change in the magnification, and a surface number on the magnification side of the spacing is shown in [ ] in the column of D. Values shown in Table 1 are values in a state where a projection distance is 1.29 meters (m). The projection distance is a distance on the optical axis from the magnification-side imaging plane to a lens surface closest to the magnification side.

Table 2 shows a zoom ratio Zr, an absolute value |f| of a focal length, a back focus on the reduction side as an air conversion distance, an F-number FNo., a maximum full angle of view 2ω, and the variable surface spacings at a d line. The zoom ratio is synonymous with a zoom magnification. Here, [°] in a field of 2ω indicates that the unit of 2ω is degree. Table 2 shows each value in a wide-angle end state, a middle focal length state, and a telephoto end state in columns labeled “Wide”, “Middle”, and “Tele”, respectively.

In the basic lens data, a surface number of an aspherical surface is marked with *, and a field of the curvature radius of the aspherical surface shows a value of a paraxial curvature radius. In Table 3, a column of Sn shows the surface number of the aspherical surface, and columns of KA and Am show numerical values of the aspherical coefficients for each aspherical surface. Here, m in Am is an integer greater than or equal to 3 and varies depending on the surface. For example, for the first surface of Example 1, m=3, 4, 5, 6, . . . 20 is established. In the numerical values of the aspherical coefficients in Table 3, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z),
h: a height (a distance from the optical axis Z to the lens surface),
C: a reciprocal of the paraxial curvature radius, and
KA and Am: aspherical coefficients, and
Σ in the aspheric equation means a sum total related to m.

In the data of each table, the unit of angle is degree, and the unit of length is millimeter (mm). However, since the optical system can be used by proportionally magnifying or proportionally reducing it, other appropriate units can also be used. Each table below shows numerical values rounded in a predetermined number of digits.

TABLE 1A
Example 1

| Sn | R | D | Nd | vd |
|---|---|---|---|---|
| *1 | −31.5789 | 8.0200 | 1.53638 | 56.09 |
| *2 | −72.6825 | 11.9200 | | |
| 3 | 70.1864 | 2.2000 | 1.83481 | 42.72 |
| 4 | 30.9568 | 6.5277 | | |
| 5 | 49.3774 | 1.6300 | 1.84666 | 23.78 |
| 6 | 23.7458 | 37.3300 | | |
| 7 | −24.0313 | 0.9500 | 1.94595 | 17.98 |
| 8 | −51.0312 | 0.4000 | | |
| *9 | −147.2639 | 8.7900 | 1.58913 | 61.15 |
| *10 | −24.3410 | 0.4000 | | |
| 11 | −341.8150 | 10.9800 | 1.49700 | 81.61 |
| 12 | −31.8585 | 7.0000 | | |
| 13 | 575.4488 | 1.7600 | 1.94595 | 17.98 |
| 14 | 67.2591 | 13.6000 | 1.49700 | 81.61 |
| 15 | −67.2591 | 43.7100 | | |
| 16 | 83.3405 | 13.2600 | 1.86966 | 20.02 |
| 17 | −293.8238 | 0.5000 | | |
| 18 | 38.7193 | 8.3400 | 1.94595 | 17.98 |
| 19 | 53.7772 | 3.8952 | | |
| 20 | 90.9303 | 1.8500 | 1.85883 | 30.00 |
| 21 | 57.8167 | 18.1700 | | |
| 22 | −75.6119 | 8.0000 | 1.53172 | 48.84 |
| 23 | 55.2510 | 62.2000 | | |

TABLE 1B
Example 1

| Sn | R | D | Nd | vd |
|---|---|---|---|---|
| 24 | −282.9321 | 3.9500 | 1.86966 | 20.02 |
| 25 | −78.5846 | DD[25] | | |
| 26 | 233.3112 | 3.4500 | 1.77250 | 49.62 |
| 27 | −233.3112 | DD[27] | | |
| 28 | 39.2990 | 6.4100 | 1.86966 | 20.02 |
| 29 | 105.9040 | 0.5000 | | |
| 30 | 36.8970 | 3.4200 | 1.72916 | 54.67 |
| 31 | 49.3683 | 2.0953 | | |
| 32 | 100.0332 | 3.4000 | 1.80809 | 22.76 |
| 33 | 25.0579 | DD[33] | | |
| 34 | 175.5824 | 1.1200 | 1.94595 | 17.98 |
| 35 | 34.6014 | 0.0744 | | |
| 36 | 35.0768 | 16.8800 | 1.49700 | 81.61 |
| 37 | −22.9381 | 0.0695 | | |
| 38 | −22.8259 | 1.2500 | 1.85451 | 25.15 |
| 39 | −97.5910 | 2.6200 | | |
| 40 | 978.6219 | 11.4500 | 1.51860 | 69.89 |
| 41 | 34.4293 | DD[41] | | |
| 42 | 196.1495 | 3.9600 | 1.86966 | 20.02 |
| 43 | −196.1495 | 22.4000 | | |
| 44 | 00 | 42.6940 | 1.51680 | 64.20 |
| 45 | 00 | | | |

TABLE 2
Example 1

| | Wide | Middle | Tele |
|---|---|---|---|
| Zr | 1.00 | 1.12 | 1.25 |
| | 9.09 | 10.19 | 11.37 |
| Bf | 50.49 | 50.45 | 50.38 |
| FNo. | 2.01 | 2.12 | 2.22 |
| 2ω [°] | 129.4 | 124.2 | 118.8 |
| DD[25] | 33.8315 | 18.7075 | 4.9246 |
| DD[27] | 6.0002 | 14.7507 | 20.1753 |
| DD[33] | 19.1100 | 18.3727 | 18.4656 |
| DD[41] | 8.8440 | 15.9548 | 24.2202 |

TABLE 3
Example 1

| Sn | 1 | 2 | 9 | 10 |
|---|---|---|---|---|
| KA | −1.9301263E+00 | −5.1223453E−01 | 1.0000000E+00 | 1.0000000E+00 |
| A3 | 1.9490522E−05 | 4.4272660E−05 | 0.0000000E+00 | 0.0000000E+00 |
| A4 | 7.3329423E−05 | 6.6735719E−05 | −8.2520251E−06 | 2.8845137E−05 |
| A5 | −3.9957555E−06 | −2.9987247E−06 | −1.1554976E−07 | −1.3790360E−05 |
| A6 | 3.5183260E−08 | 1.1415773E−10 | 4.2035155E−08 | 2.7943379E−06 |
| A7 | 3.9388645E−09 | 4.4137131E−09 | −9.7854955E−10 | −1.6422983E−07 |
| A8 | −1.2955380E−10 | −1.5870496E−10 | −9.7329857E−11 | −1.9507507E−08 |
| A9 | −7.4649700E−13 | −1.3730587E−13 | 2.9125893E−12 | 2.8016785E−09 |
| A10 | 1.0149109E−13 | 1.5948416E−13 | 1.2077936E−13 | −2.2487680E−12 |
| A11 | −9.7828781E−16 | −2.9203772E−15 | −4.0983820E−15 | −1.1538192E−11 |
| A12 | −3.5200585E−17 | −6.5000580E−17 | −4.8029278E−17 | −7.5784885E−14 |
| A13 | 7.0355873E−19 | 2.3616522E−18 | 4.1435791E−18 | 3.5813153E−14 |
| A14 | 4.8424083E−21 | 5.5361142E−21 | −7.7248504E−20 | 2.7319017E−15 |
| A15 | −2.0208468E−22 | −8.3469693E−22 | −2.7185257E−21 | −2.4962616E−16 |
| A16 | 2.6896574E−25 | 3.7660940E−24 | 1.1408300E−22 | −6.6326969E−18 |
| A17 | 2.7939132E−26 | 1.4473474E−25 | 1.0219656E−24 | 8.7266021E−19 |
| A18 | −1.4847323E−28 | −1.1788617E−27 | −5.5425669E−26 | −7.2692453E−21 |
| A19 | −1.5370501E−30 | −9.9002288E−30 | −1.7292403E−28 | −8.7419090E−22 |
| A20 | 1.1800262E−32 | 1.0295969E−31 | 8.8927497E−30 | 1.9088403E−23 |

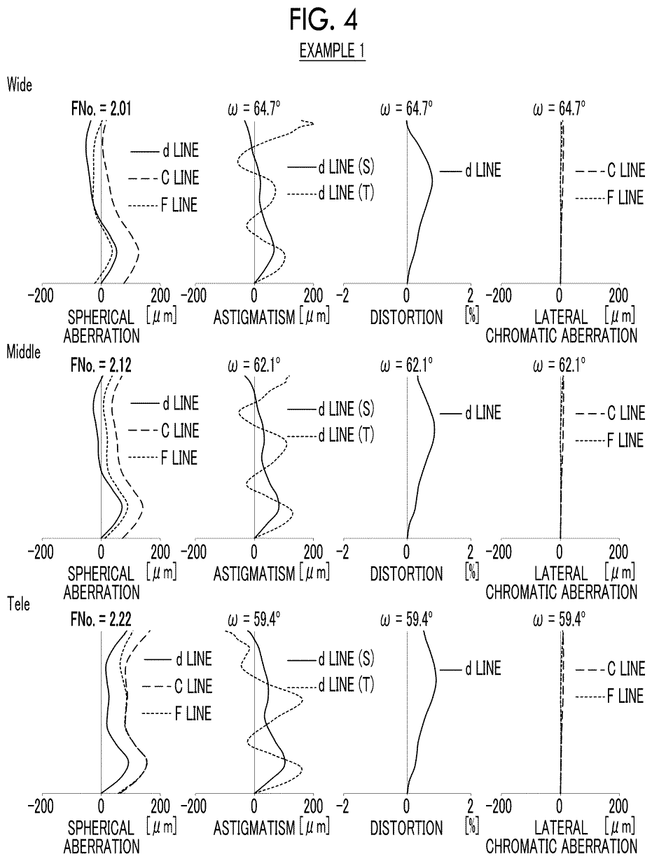

FIG. 4 shows each aberration diagram of the imaging optical system of Example 1 in a state where the projection distance is 1.29 meters (m). FIG. 4 shows, in order from the left, spherical aberration, astigmatism, distortion, and lateral chromatic aberration. In FIG. 4, an upper part labeled “Wide” shows aberration in the wide-angle end state, a middle part labeled “Middle” shows aberration in the middle focal length state, and a lower part labeled “Tele” shows aberration in the telephoto end state. In the spherical aberration diagram, aberration related to a d line, a C line, and an F line is shown by a solid line, a long broken line, and a short broken line, respectively. In the astigmatism diagram, aberration related to the d line in a sagittal direction is shown by a solid line, and aberration related to the d line in a tangential direction is shown by a short broken line. In the distortion diagram, aberration related to the d line is shown by a solid line. In the lateral chromatic aberration diagram, aberration related to the C line and the F line is shown by a long broken line and a short broken line, respectively. In the spherical aberration diagram, a value of the F-number is shown after “FNO.=”. In other aberration diagrams, a value of the maximum half angle of view is shown after “ω=”.

FIG. 3 shows a cross-sectional view of a configuration of a modification example of the imaging optical system of Example 1. The configuration of the example in FIG. 3 is described above. Thus, its description will not be repeated.

Symbols, meanings, description methods, and illustration methods of each data related to Example 1 and the modification example are basically the same as those in the following examples, unless otherwise specified. Thus, their description will not be repeated below. The screen Scr is not shown in the cross-sectional views of the examples below.

### Example 2

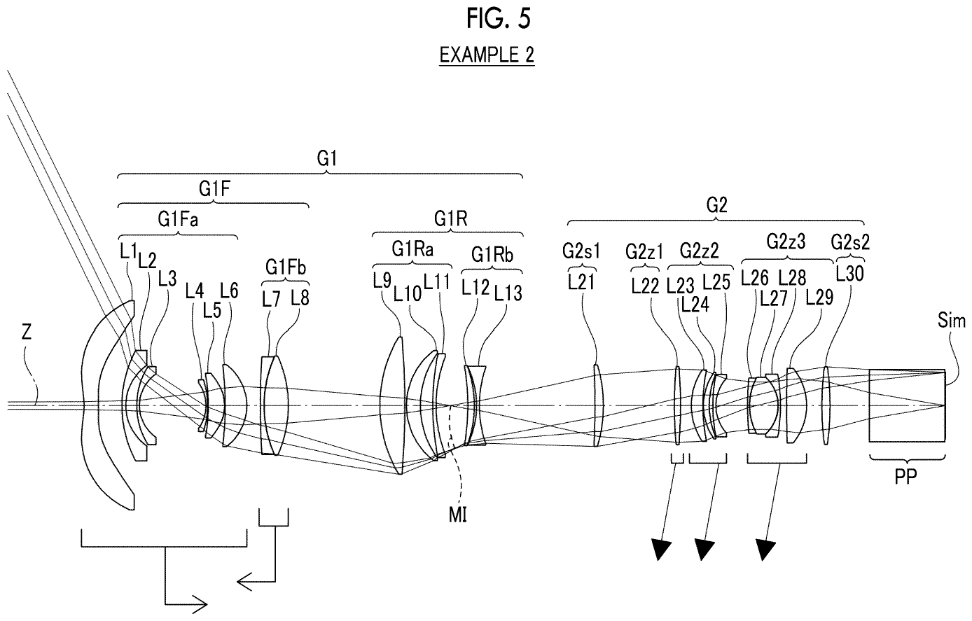

FIG. 5 shows a cross-sectional view of a configuration and luminous fluxes of an imaging optical system of Example 2. The imaging optical system of Example 2 is a zoom lens and consists of, in order from the magnification side to the reduction side, the first optical system G1 and the second optical system G2.

The first optical system G1 consists of, in order from the magnification side to the reduction side, the first F group GIF having positive refractive power, and the first R group G1R having positive refractive power. The first F group GIF is a focus group. The first F group GIF consists of, in order from the magnification side to the reduction side, the first Fa sub-group G1Fa and the first Fb sub-group G1Fb. During focusing from the short range to the long range, the first Fa sub-group G1Fa moves to the reduction side, and the first Fb sub-group G1Fb moves to the magnification side. The first R group G1R consists of, in order from the magnification side to the reduction side, the first Ra sub-group G1Ra having positive refractive power, and the first Rb sub-group G1Rb having negative refractive power. The intermediate image MI is formed between the first Ra sub-group G1Ra and the first Rb sub-group G1Rb. The first Fa sub-group G1Fa consists of the lenses L1 to L6. The first Fb sub-group G1Fb consists of the lenses L7 and L8. The first Ra sub-group G1Ra consists of the lenses L9 to L11. The first Rb sub-group G1Rb consists of the lenses L12 and L13.

The second optical system G2 consists of, in order from the magnification side to the reduction side, the first stationary lens group G2s1 having positive refractive power, the first moving lens group G2z1 having positive refractive power, the second moving lens group G2z2 having positive refractive power, the third moving lens group G2z3 having positive refractive power, and the second stationary lens group G2s2 having positive refractive power. During a change in the magnification, the first stationary lens group G2s1 and the second stationary lens group G2s2 remain stationary with respect to the reduction-side imaging plane, and the first moving lens group G2z1, the second moving lens group G2z2, and the third moving lens group G2z3 move along the optical axis Z by changing spacings with respect to adjacent lens groups. The first stationary lens group G2s1 consists of the lens L21. The first moving lens group G2z1 consists of the lens L22. The second moving lens group G2z2 consists of the lenses L23 to L25. The third moving lens group G2z3 consists of the lenses L26 to L29. The second stationary lens group G2s2 consists of the lens L30.

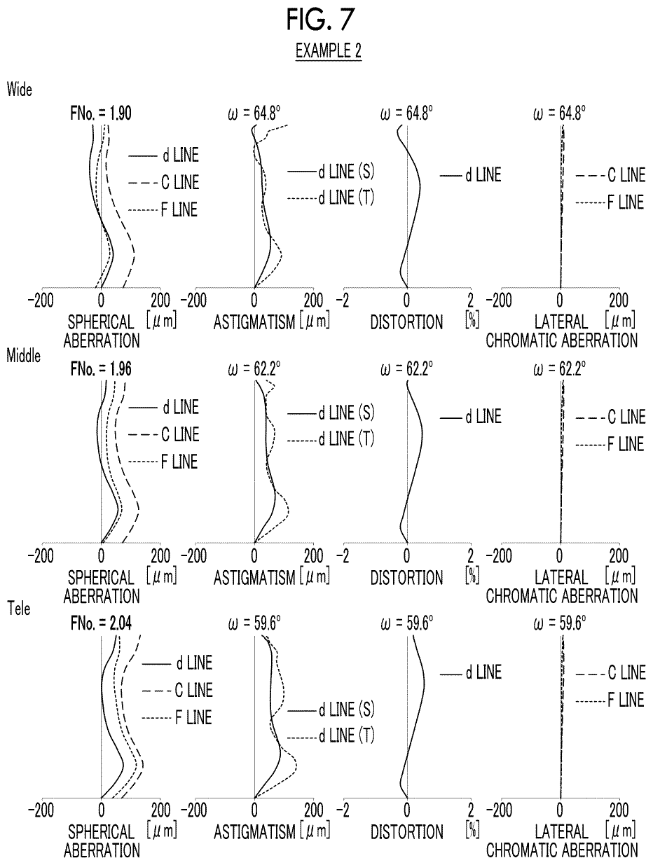

For the imaging optical system of Example 2, Tables 4A and 4B show basic lens data, Table 5 shows specifications and variable surface spacings, Table 6 shows aspherical coefficients, and FIG. 7 shows each aberration diagram. The basic lens data and each aberration diagram are shown in a state where the projection distance is 1.29 meters (m).

TABLE 4A
Example 2

| Sn | R | D | Nd | vd |
|---|---|---|---|---|
| *1 | −43.4571 | 8.1992 | 1.53638 | 56.09 |
| *2 | −188.9518 | 13.2519 | | |
| 3 | 72.2686 | 2.2000 | 1.83481 | 42.72 |
| 4 | 29.7863 | 6.1524 | | |
| 5 | 44.7465 | 1.5500 | 1.85883 | 30.00 |
| 6 | 23.3212 | 37.6088 | | |
| 7 | −23.7815 | 0.9500 | 1.94595 | 17.98 |
| 8 | −50.8447 | 0.4000 | | |
| *9 | −135.4477 | 9.1902 | 1.58913 | 61.15 |
| *10 | −24.4752 | 0.4000 | | |
| 11 | −202.5292 | 12.2024 | 1.49700 | 81.61 |
| 12 | −31.1221 | 7.7653 | | |
| 13 | 562.4261 | 2.0463 | 1.94595 | 17.98 |
| 14 | 73.7413 | 13.7281 | 1.49700 | 81.61 |
| 15 | −73.7413 | 51.8235 | | |
| 16 | 82.2590 | 14.1165 | 1.86966 | 20.02 |
| 17 | −493.3859 | 0.9196 | | |
| 18 | 41.9144 | 7.8898 | 1.94595 | 17.98 |
| 19 | 54.5936 | 6.9562 | | |
| 20 | 156.6682 | 1.9200 | 1.87070 | 40.73 |
| 21 | 81.6557 | 17.9614 | | |
| 22 | −140.2255 | 3.6362 | 1.77250 | 49.62 |
| 23 | −70.7047 | 1.2661 | | |
| 24 | −55.4507 | 1.6701 | 1.59270 | 35.31 |
| 25 | 73.0284 | 65.1045 | | |

TABLE 4B
Example 2

| Sn | R | D | Nd | vd |
|---|---|---|---|---|
| 26 | −443.3871 | 4.7182 | 1.86966 | 20.02 |
| 27 | −86.4380 | DD[27] | | |
| 28 | 275.3807 | 3.5066 | 1.72916 | 54.67 |
| 29 | −275.3807 | DD[29] | | |
| 30 | 38.9264 | 6.5832 | 1.86966 | 20.02 |
| 31 | 110.2335 | 0.3002 | | |
| 32 | 35.4326 | 3.2778 | 1.80610 | 33.27 |
| 33 | 48.7521 | 2.0289 | | |
| 34 | 96.1655 | 1.7760 | 1.80809 | 22.76 |
| 35 | 25.1053 | DD[35] | | |
| 36 | 199.5248 | 1.1000 | 1.94595 | 17.98 |
| 37 | 36.0324 | 0.0604 | | |
| 38 | 36.4048 | 16.0623 | 1.49700 | 81.61 |
| 39 | −23.3693 | 0.0806 | | |
| 40 | −23.2549 | 1.3200 | 1.85451 | 25.15 |
| 41 | −109.7134 | 3.5013 | | |
| 42 | 852.5804 | 11.2985 | 1.51860 | 69.89 |
| 43 | −35.7089 | DD[43] | | |
| 44 | 179.4453 | 4.6040 | 1.86966 | 20.02 |
| 45 | −179.4453 | 22.6400 | | |
| 46 | 00 | 42.6940 | 1.51680 | 64.20 |
| 47 | 00 | | | |

TABLE 5
Example 2

| | Wide | Middle | Tele |
|---|---|---|---|
| Zr | 1.00 | 1.12 | 1.25 |
| \|f\| | 9.10 | 10.19 | 11.35 |
| Bf | 50.73 | 50.71 | 50.69 |
| FNo. | 1.90 | 1.96 | 2.04 |
| 2ω [°] | 129.6 | 124.4 | 119.2 |
| DD[27] | 40.1556 | 22.2283 | 5.8662 |
| DD[29] | 6.0774 | 17.6508 | 26.2501 |
| DD[35] | 17.8788 | 17.5883 | 17.7411 |
| DD[43] | 8.6392 | 15.2834 | 22.8937 |

TABLE 6
Example 2

| Sn | 1 | 2 | 9 | 10 |
|---|---|---|---|---|
| KA | −1.2895302E+00 | 7.2493145E+00 | 1.0000000E+00 | 1.0000000E+00 |
| A3 | −1.1572574E−04 | −7.1803084E−05 | 0.0000000E+00 | 0.0000000E+00 |
| A4 | 7.2323795E−05 | 6.1627322E−05 | −8.5206161E−06 | 1.7553700E−05 |
| A5 | −3.4696551E−06 | −2.4910902E−06 | 5.0504927E−07 | −6.6844848E−06 |
| A6 | 2.2455946E−08 | −1.7711975E−08 | −4.6622490E−08 | 1.4259904E−06 |
| A7 | 3.4078970E−09 | 3.9880098E−09 | 1.9963165E−09 | −1.4424577E−07 |
| A8 | −1.0188823E−10 | −9.6861700E−11 | 2.8644854E−10 | 4.1167210E−09 |
| A9 | −7.2564998E−13 | −1.1964651E−12 | −2.6614428E−11 | 7.3952756E−10 |
| A10 | 7.8719483E−14 | 1.0098052E−13 | −3.6862189E−13 | −1.1950264E−10 |
| A11 | −6.8552111E−16 | −1.0044062E−15 | 8.7509099E−14 | 8.3978461E−12 |
| A12 | −2.6630949E−17 | −4.2868481E−17 | −3.9412409E−16 | 2.9336255E−14 |
| A13 | 4.9868910E−19 | 1.0165836E−18 | −1.3924560E−16 | −5.8779823E−14 |
| A14 | 3.6369933E−21 | 5.9993405E−21 | 1.5169306E−18 | 3.7526294E−15 |
| A15 | −1.3938547E−22 | −3.6029390E−22 | 1.1955975E−19 | 4.0529432E−17 |
| A16 | 1.4946955E−25 | 1.0150229E−24 | −1.6334631E−21 | −1.3073577E−17 |
| A17 | 1.8619501E−26 | 6.0152543E−26 | −5.3183479E−23 | 3.7529125E−19 |
| A18 | −9.4216278E−29 | −4.2009477E−28 | 7.9804476E−25 | 9.3196772E−21 |
| A19 | −9.8734627E−31 | −3.8935990E−30 | 9.6160833E−27 | −6.4937400E−22 |
| A20 | 7.3121643E−33 | 3.6738106E−32 | −1.5164786E−28 | 9.1814779E−24 |

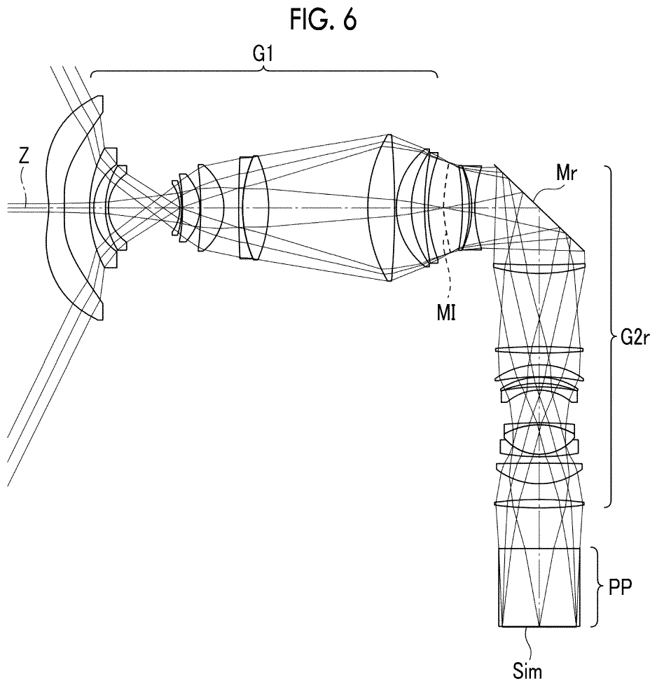

FIG. 6 shows a configuration and luminous fluxes of a modification example of Example 2 at the wide-angle end. The imaging optical system in FIG. 6 consists of, in order from the magnification side to the reduction side along the optical path, the first optical system G1 and the second optical system G2r. The second optical system G2r in FIG. 6 is different from the second optical system G2 of Example 2 in that the mirror Mr is disposed closest to the magnification side in the second optical system G2r, and the mirror Mr bends the optical path. Other configurations of the imaging optical system in FIG. 6 are the same as those of the imaging optical system of Example 2.

### Example 3

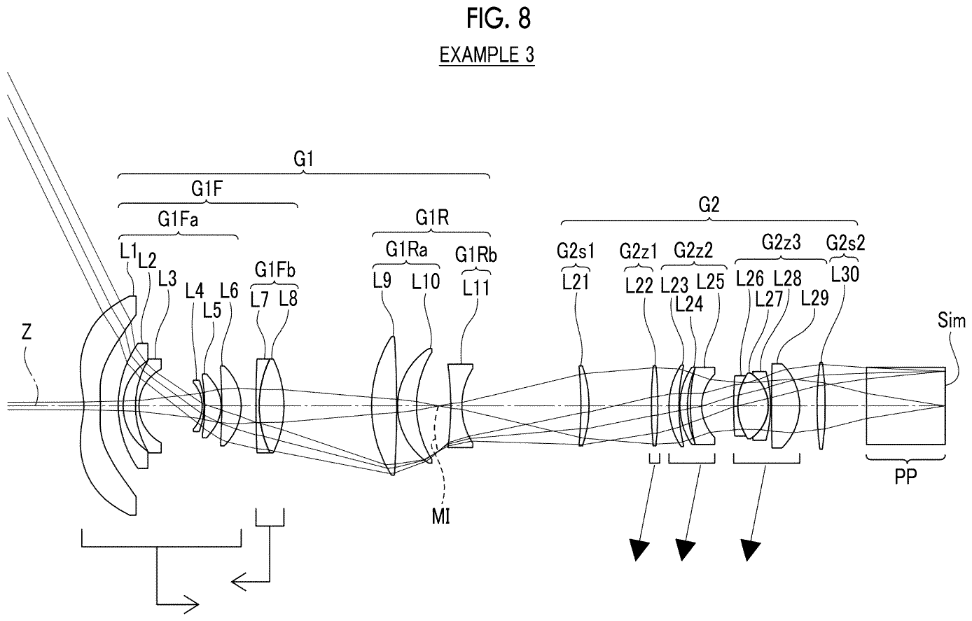

FIG. 8 shows a cross-sectional view of a configuration and luminous fluxes of an imaging optical system of Example 3. The imaging optical system of Example 3 is a zoom lens and consists of, in order from the magnification side to the reduction side, the first optical system G1 and the second optical system G2.

The first optical system G1 consists of, in order from the magnification side to the reduction side, the first F group GIF having positive refractive power, and the first R group G1R having positive refractive power. The first F group GIF is a focus group. The first F group GIF consists of, in order from the magnification side to the reduction side, the first Fa sub-group first Rb sub-group G1Rb having negative refractive power. The intermediate image MI is formed between the first Ra sub-group G1Ra and the first Rb sub-group G1Rb. The first Fa sub-group G1Fa consists of the lenses L1 to L6. The first Fb sub-group G1Fb consists of the lenses L7 and L8. The first Ra sub-group G1Ra consists of the lenses L9 and L10. The first Rb sub-group G1Rb consists of the lens L11.

The second optical system G2 consists of, in order from the magnification side to the reduction side, the first stationary lens group G2s1 having positive refractive power, the first moving lens group G2z1 having positive refractive power, the second moving lens group G2z2 having positive refractive power, the third moving lens group G2z3 having positive refractive power, and the second stationary lens group G2s2 having positive refractive power. During a change in the magnification, the first stationary lens group G2s1 and the second stationary lens group G2s2 remain stationary with respect to the reduction-side imaging plane, and the first moving lens group G2z1, the second moving lens group G2z2, and the third moving lens group G2z3 move along the optical axis Z by changing spacings with respect to adjacent lens groups. The first stationary lens group G2s1 consists of the lens L21. The first moving lens group G2z1 consists of the lens L22. The second moving lens group G2z2 consists of the lenses L23 to L25. The third moving lens group G2z3 consists of the lenses L26 to L29. The second stationary lens group G2s2 consists of the lens L30.

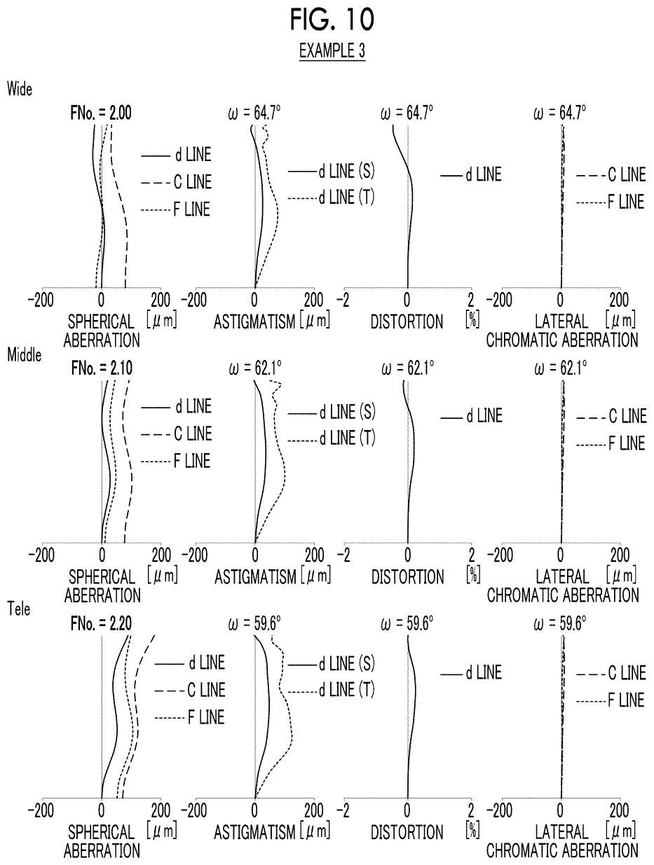

For the imaging optical system of Example 3, Tables 7A and 7B show basic lens data, Table 8 shows specifications and variable surface spacings, Table 9 shows aspherical coefficients, and FIG. 10 shows each aberration diagram. The basic lens data and each aberration diagram are shown in a state where the projection distance is 1.29 meters (m).

TABLE 7A
Example 3

| Sn | R | D | Nd | vd |
|---|---|---|---|---|
| *1 | −32.8285 | 8.9009 | 1.53638 | 56.09 |
| *2 | −88.9944 | 9.6478 | | |
| 3 | 63.7938 | 2.6004 | 1.83481 | 42.72 |
| 4 | 31.0522 | 6.7436 | | |
| 5 | 52.4223 | 1.8260 | 1.85883 | 30.00 |
| 6 | 23.9195 | 34.2218 | | |
| 7 | −20.2466 | 0.9500 | 1.94595 | 17.98 |
| 8 | −40.9190 | 0.3991 | | |
| *9 | −113.4537 | 8.8444 | 1.58913 | 61.15 |
| *10 | −21.7784 | 0.3991 | | |
| 11 | −359.1041 | 10.4834 | 1.49700 | 81.61 |
| 12 | −32.0103 | 7.9992 | | |
| 13 | 561.0030 | 1.7492 | 1.94595 | 17.98 |
| 14 | 62.9254 | 13.4014 | 1.49700 | 81.61 |
| 15 | −62.9254 | 47.3718 | | |
| 16 | 76.2841 | 13.5824 | 1.86966 | 20.02 |
| 17 | −621.2707 | 0.4992 | | |
| 18 | 39.4123 | 10.2615 | 1.86966 | 20.02 |
| 19 | 59.7956 | 18.4860 | | |
| 20 | −175.6977 | 6.0009 | 1.80518 | 25.46 |
| 21 | 40.5107 | 64.0666 | | |

TABLE 7B
Example 3

| Sn | R | D | Nd | vd |
|---|---|---|---|---|
| 22 | −236.9058 | 4.3731 | 1.86966 | 20.02 |
| 23 | −72.8014 | DD[23] | | |
| 24 | 239.1652 | 3.5620 | 1.77250 | 49.62 |
| 25 | −239.1652 | DD[25] | | |
| 26 | 43.7043 | 5.3562 | 1.86966 | 20.02 |
| 27 | 100.1896 | 0.5254 | | |
| 28 | 39.7439 | 4.0497 | 1.80420 | 46.50 |
| 29 | 55.7102 | 1.6357 | | |
| 30 | 91.4743 | 6.1349 | 1.80518 | 25.46 |
| 31 | 25.9065 | DD[31] | | |
| 32 | 251.1927 | 2.2009 | 1.94595 | 17.98 |
| 33 | 34.0491 | 0.0697 | | |
| 34 | 34.4991 | 16.3909 | 1.49700 | 81.61 |
| 35 | −22.6828 | 0.0697 | | |
| 36 | −22.5645 | 1.1995 | 1.85451 | 25.15 |
| 37 | −75.7060 | 0.4992 | | |
| 38 | 801.8459 | 15.2433 | 1.48749 | 70.44 |
| 39 | −34.0669 | DD[39] | | |
| 40 | 191.4601 | 4.4380 | 1.86966 | 20.02 |
| 41 | −191.4601 | 22.1200 | | |
| 42 | 00 | 42.6940 | 1.51680 | 64.20 |
| 43 | 00 | | | |

TABLE 8
Example 3

| | Wide | Middle | Tele |
|---|---|---|---|
| Zr | 1.00 | 1.12 | 1.25 |
| \|f\| | 9.09 | 10.19 | 11.30 |
| Bf | 50.20 | 50.17 | 50.14 |
| FNo. | 2.00 | 2.10 | 2.20 |
| 2ω [°] | 129.4 | 124.2 | 119.2 |
| DD[23] | 33.7050 | 18.1080 | 4.8027 |
| DD[25] | 6.0000 | 15.1427 | 20.7363 |
| DD[31] | 17.2775 | 16.6390 | 16.6559 |
| DD[39] | 9.4262 | 16.5179 | 24.2146 |

TABLE 9
Example 3

| Sn | 1 | 2 | 9 | 10 |
|---|---|---|---|---|
| KA | −8.8661207E−01 | −1.4965713E+01 | 1.0000000E+00 | 1.0000000E+00 |
| A3 | −6.1828608E−05 | −4.1455210E−05 | 0.0000000E+00 | 0.0000000E+00 |
| A4 | 8.3629746E−05 | 7.1328097E−05 | −1.0322769E−05 | 4.5444981E−06 |
| A5 | −4.3173775E−06 | −3.2338391E−06 | 2.6044184E−07 | 6.5825449E−07 |
| A6 | 3.5840134E−08 | −1.7438653E−08 | 8.8476706E−08 | −1.6420713E−07 |
| A7 | 4.1369601E−09 | 5.6881950E−09 | −1.0393520E−08 | 1.1684943E−08 |
| A8 | −1.3182649E−10 | −1.4331228E−10 | 1.8930683E−10 | 1.3253648E−09 |
| A9 | −8.2412340E−13 | −2.2882383E−12 | 4.7801916E−11 | −1.9286033E−10 |
| A10 | 1.0152060E−13 | 1.6255788E−13 | −2.7767878E−12 | 1.0406922E−12 |
| A11 | −9.1961989E−16 | −1.0586444E−15 | −7.3605936E−14 | 8.4292199E−13 |
| A12 | −3.4952106E−17 | −7.8484898E−17 | 7.8425619E−15 | −2.6084611E−14 |
| A13 | 6.6801989E−19 | 1.4320016E−18 | 5.4566730E−17 | −1.3871373E−15 |
| A14 | 4.8825940E−21 | 1.5282691E−20 | −9.0818518E−18 | 6.2708482E−17 |
| A15 | −1.9074104E−22 | −5.6610779E−22 | −1.6084806E−20 | 5.1936853E−19 |
| A16 | 2.1201110E−25 | 4.0781554E−25 | 3.8262122E−21 | −3.0823023E−20 |
| A17 | 2.6145237E−26 | 1.0290426E−25 | | |
| A18 | −1.3521985E−28 | −5.9837904E−28 | | |
| A19 | −1.4246109E−30 | −7.1924476E−30 | | |
| A20 | 1.0808143E−32 | 6.2663912E−32 | | |

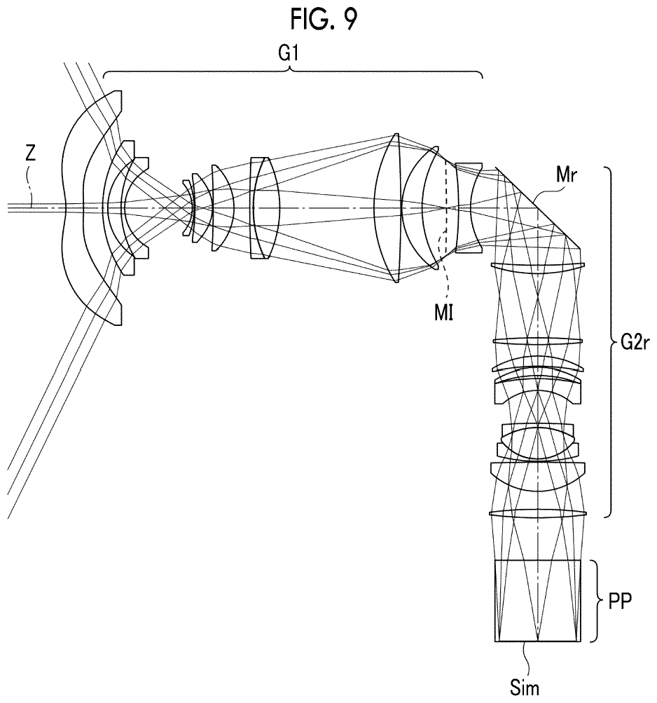

FIG. 9 shows a configuration and luminous fluxes of a modification example of Example 3 at the wide-angle end. The imaging optical system in FIG. 9 consists of, in order from the magnification side to the reduction side along the optical path, the first optical system G1 and the second optical system G2r. The second optical system G2r in FIG. 9 is different from the second optical system G2 of Example 3 in that the mirror Mr is disposed closest to the magnification side in the second optical system G2r, and the mirror Mr bends the optical path. Other configurations of the imaging optical system in FIG. 9 are the same as those of the imaging optical system of Example 3.

### Example 4

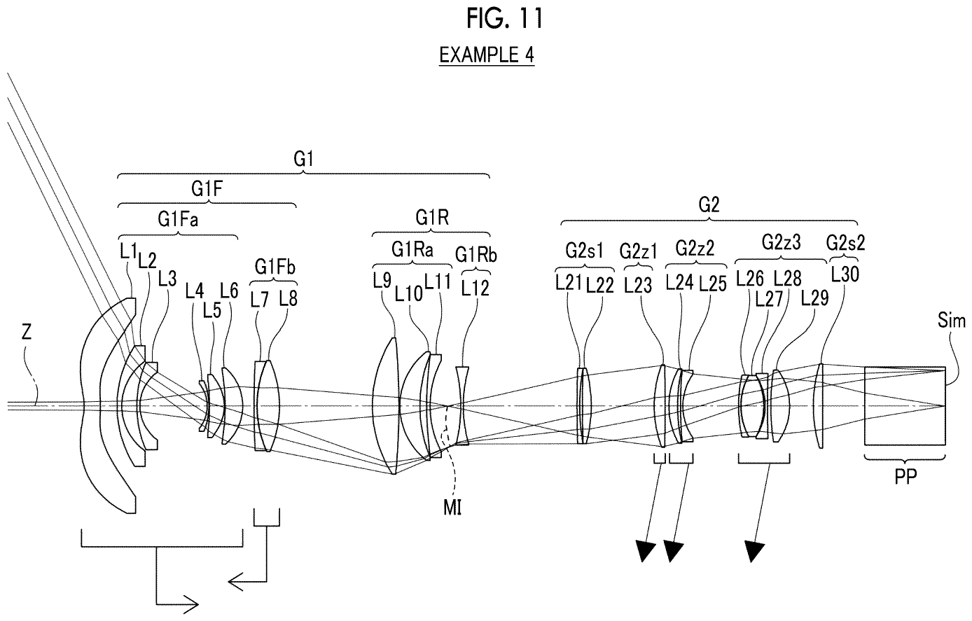

FIG. 11 shows a cross-sectional view of a configuration and luminous fluxes of an imaging optical system of Example 4. The imaging optical system of Example 4 is a zoom lens and consists of, in order from the magnification side to the reduction side, the first optical system G1 and the second optical system G2.

The first optical system G1 consists of, in order from the magnification side to the reduction side, the first F group GIF having positive refractive power, and the first R group G1R having positive refractive power. The first F group GIF is a focus group. The first F group GIF consists of, in order from the magnification side to the reduction side, the first Fa sub-group G1Fa and the first Fb sub-group G1Fb. During focusing from the short range to the long range, the first Fa sub-group G1Fa moves to the reduction side, and the first Fb sub-group G1Fb moves to the magnification side. The first R group G1R consists of, in order from the magnification side to the reduction side, the first Ra sub-group G1Ra having positive refractive power, and the first Rb sub-group G1Rb having negative refractive power. The intermediate image MI is formed between the first Ra sub-group G1Ra and the first Rb sub-group G1Rb. The first Fa sub-group G1Fa consists of the lenses L1 to L6. The first Fb sub-group G1Fb consists of the lenses L7 and L8. The first Ra sub-group G1Ra consists of the lenses L9 to L11. The first Rb sub-group G1Rb consists of the lens L12.

The second optical system G2 consists of, in order from the magnification side to the reduction side, the first stationary lens group G2s1, the first moving lens group G2z1 having positive refractive power, the second moving lens group G2z2 having negative refractive power, the third moving lens group G2z3 having positive refractive power, and the second stationary lens group G2s2 having positive refractive power. During a change in the magnification, the first stationary lens group G2s1 and the second stationary lens group G2s2 remain stationary with respect to the reduction-side imaging plane, and the first moving lens group G2z1, the second moving lens group G2z2, and the third moving lens group G2z3 move along the optical axis Z by changing spacings with respect to adjacent lens groups. The first stationary lens group G2s1 consists of the lenses L21 and L22. The first moving lens group G2z1 consists of the lens L23. The second moving lens group G2z2 consists of the lenses L24 and L25. The third moving lens group G2z3 consists of the lenses L26 to L29. The second stationary lens group G2s2 consists of the lens L30.

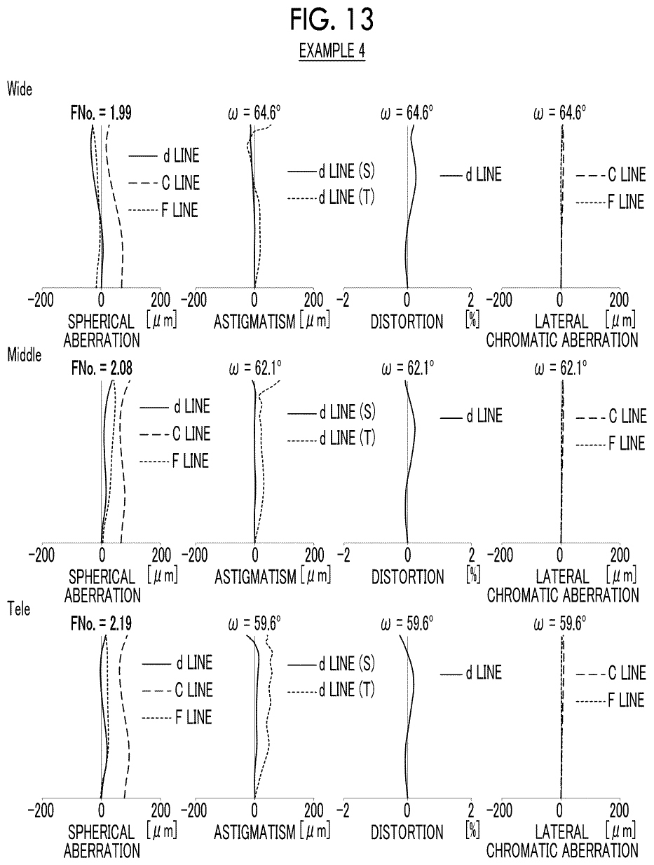

For the imaging optical system of Example 4, Tables 10A and 10B show basic lens data, Table 11 shows specifications and variable surface spacings, Table 12 shows aspherical coefficients, and FIG. 13 shows each aberration diagram. The basic lens data and each aberration diagram are shown in a state where the projection distance is 1.29 meters (m).

TABLE 10A
Example 4

| Sn | R | D | Nd | vd |
|---|---|---|---|---|
| *1 | −33.0669 | 8.6009 | 1.53638 | 56.09 |
| *2 | −101.5063 | 8.8724 | | |
| 3 | 63.7180 | 2.4991 | 1.83481 | 42.72 |
| 4 | 31.1138 | 7.9391 | | |
| 5 | 62.6691 | 1.6506 | 1.83481 | 42.72 |
| 6 | 23.4967 | 35.5673 | | |
| 7 | −20.2755 | 0.9009 | 1.94595 | 17.98 |
| 8 | −37.5462 | 0.2991 | | |
| *9 | −132.8002 | 7.8532 | 1.58913 | 61.15 |
| *10 | −23.1211 | 0.3991 | | |
| 11 | −126.5143 | 9.3269 | 1.48749 | 70.44 |
| 12 | −28.7573 | 5.9996 | | |
| 13 | 525.4537 | 1.5996 | 1.94595 | 17.98 |
| 14 | 64.1272 | 11.8481 | 1.49700 | 81.61 |
| 15 | −64.1272 | 49.1170 | | |
| 16 | 71.9290 | 14.0208 | 1.86966 | 20.02 |
| 17 | −423.6278 | 0.5000 | | |
| 18 | 38.8133 | 10.6332 | 1.86966 | 20.02 |
| 19 | 77.1668 | 3.5656 | | |
| 20 | 205.8312 | 1.7991 | 1.87070 | 40.73 |
| 21 | 56.3720 | 16.2013 | | |
| 22 | −92.5111 | 1.3993 | 1.59282 | 68.62 |
| 23 | 80.6312 | 59.7911 | | |

TABLE 10B
Example 4

| Sn | R | D | Nd | νd |
|---|---|---|---|---|
| 24 | 748.3146 | 1.3991 | 1.94595 | 17.98 |
| 25 | 124.8896 | 1.4326 | | |
| 26 | 558.6739 | 4.6824 | 1.86966 | 20.02 |
| 27 | −81.3964 | DD[27] | | |
| 28 | 66.0116 | 5.8107 | 2.00100 | 29.13 |
| 29 | −1054.5698 | DD[29] | | |
| 30 | 44.0100 | 4.5452 | 1.86966 | 20.02 |
| 31 | 90.5399 | 1.5672 | | |
| 32 | 213.0635 | 1.2997 | 1.69895 | 30.13 |
| 33 | 31.7010 | DD[33] | | |
| 34 | 81.0763 | 1.1996 | 1.94595 | 17.98 |
| 35 | 36.0741 | 0.1617 | | |
| 36 | 37.3375 | 11.9316 | 1.49700 | 81.61 |
| 37 | −37.3375 | 0.7072 | | |
| 38 | −32.3843 | 1.2500 | 1.94595 | 17.98 |
| 39 | 515.9442 | 1.8191 | | |
| 40 | 141.4476 | 9.9530 | 1.49700 | 81.61 |
| 41 | −34.8157 | DD[41] | | |
| 42 | 81.2873 | 4.8898 | 1.86966 | 20.02 |
| 43 | ∞ | 22.2690 | | |
| 44 | ∞ | 42.6940 | 1.51680 | 64.20 |
| 45 | ∞ | | | |

TABLE 11
Example 4

| | Wide | Middle | Tele |
|---|---|---|---|
| Zr | 1.00 | 1.12 | 1.25 |
| \|f\| | 9.08 | 10.18 | 11.33 |
| Bf | 50.36 | 50.34 | 50.32 |
| FNo. | 1.99 | 2.08 | 2.19 |
| 2ω [°] | 129.2 | 124.2 | 119.2 |
| DD[27] | 33.2412 | 23.5136 | 14.7533 |
| DD[29] | 2.0006 | 3.7261 | 6.2181 |
| DD[33] | 29.4096 | 29.6869 | 28.7010 |
| DD[41] | 12.5466 | 20.2698 | 27.5267 |

TABLE 12
Example 4

| Sn | 1 | 2 | 9 | 10 |
|---|---|---|---|---|
| KA | −1.4639168E+00 | 3.1383784E+00 | 1.0000000E+00 | 1.0000000E+00 |
| A3 | −1.7711074E−04 | −1.7168423E−04 | 0.0000000E+00 | 0.0000000E+00 |
| A4 | 9.8304558E−05 | 9.2726509E−05 | −5.8093658E−06 | 7.4386274E−06 |
| A5 | −5.1491952E−06 | −4.2431113E−06 | 2.0669492E−07 | −3.4307092E−07 |
| A6 | 4.2399336E−08 | −1.9775594E−08 | 4.6928115E−08 | 2.5567670E−08 |
| A7 | 5.4420037E−09 | 9.0613479E−09 | −5.5981597E−09 | 6.7869644E−09 |
| A8 | −1.8002999E−10 | −3.0237555E−10 | 1.4141515E−10 | −6.5830679E−10 |
| A9 | −1.1597802E−12 | −2.9986653E−12 | 2.2407599E−11 | −3.2496808E−11 |
| A10 | 1.5136628E−13 | 4.0794548E−13 | −1.4596080E−12 | 6.7131914E−12 |
| A11 | −1.4685886E−15 | −5.0094684E−15 | −2.6226444E−14 | −9.3062067E−14 |
| A12 | −5.6244304E−17 | −2.3483112E−16 | 3.6123751E−15 | −2.0961138E−14 |
| A13 | 1.1494505E−18 | 6.1683409E−18 | 1.3572747E−17 | 7.9393398E−16 |
| A14 | 8.2564632E−21 | 5.0044400E−20 | −3.7201390E−18 | 1.7025407E−17 |
| A15 | −3.5491991E−22 | −2.8583408E−21 | −2.3354018E−21 | −1.2273926E−18 |
| A16 | 5.1394995E−25 | 5.8858668E−24 | 1.3971001E−21 | 1.6403095E−20 |
| A17 | 5.2586259E−26 | 6.3135779E−25 | | |
| A18 | −2.9622090E−28 | −4.4286454E−27 | | |
| A19 | −3.0944178E−30 | −5.4348819E−29 | | |
| A20 | 2.5177883E−32 | 5.4033123E−31 | | |

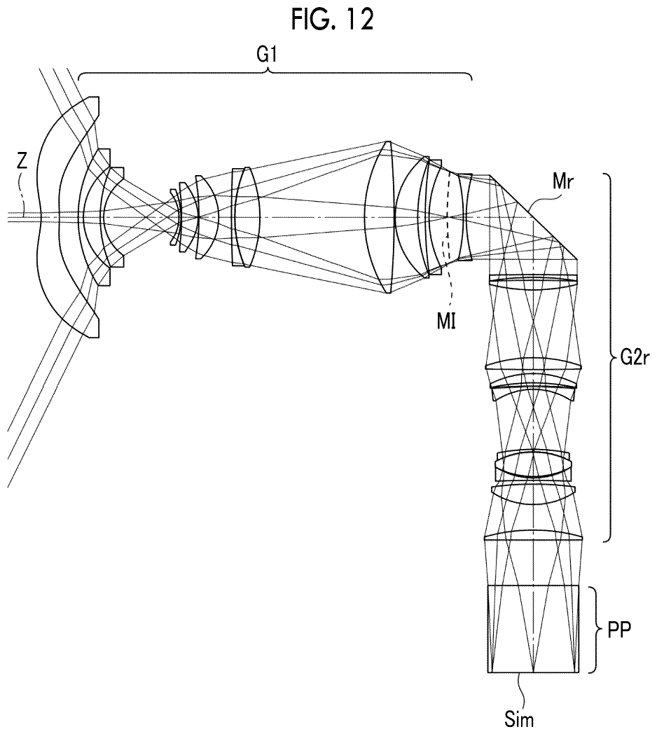

FIG. 12 shows a configuration and luminous fluxes of a modification example of Example 4 at the wide-angle end. The imaging optical system in FIG. 12 consists of, in order from the magnification side to the reduction side along the optical path, the first optical system G1 and the second optical system G2r. The second optical system G2r in FIG. 12 is different from the second optical system G2 of Example 4 in that the mirror Mr is disposed closest to the magnification side in the second optical system G2r, and the mirror Mr bends the optical path. Other configurations of the imaging optical system in FIG. 12 are the same as those of the imaging optical system of Example 4.

### Example 5

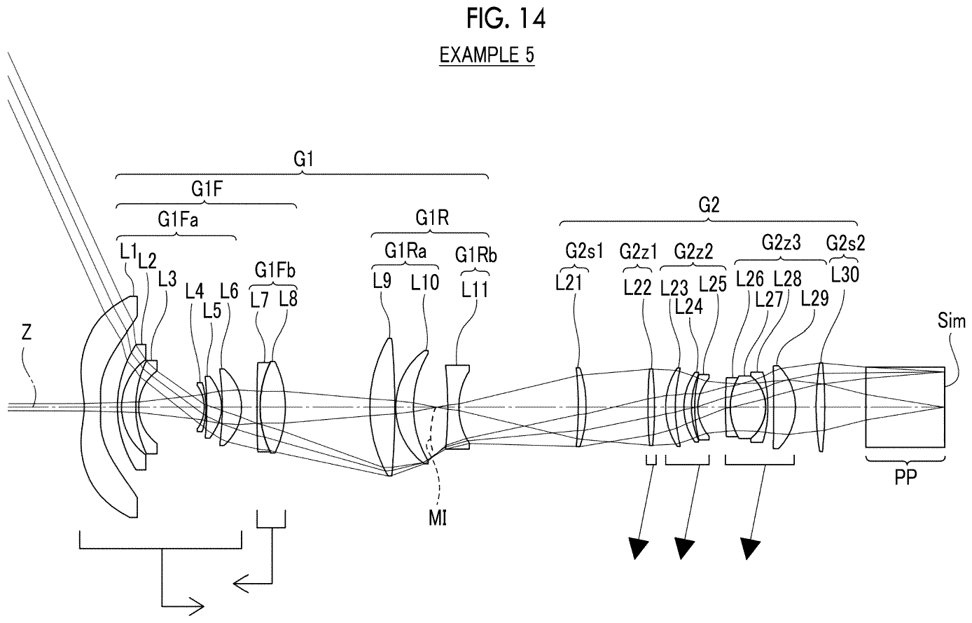

FIG. 14 shows a cross-sectional view of a configuration and luminous fluxes of an imaging optical system of Example 5. The imaging optical system of Example 5 is a zoom lens and consists of, in order from the magnification side to the reduction side, the first optical system G1 and the second optical system G2.

The first optical system G1 consists of, in order from the magnification side to the reduction side, the first F group GIF having positive refractive power, and the first R group G1R having positive refractive power. The first F group GIF is a focus group. The first F group GIF consists of, in order from the magnification side to the reduction side, the first Fa sub-group first Rb sub-group G1Rb having negative refractive power. The intermediate image MI is formed between the first Ra sub-group G1Ra and the first Rb sub-group G1Rb. The first Fa sub-group G1Fa consists of the lenses L1 to L6. The first Fb sub-group G1Fb consists of the lenses L7 and L8. The first Ra sub-group G1Ra consists of the lenses L9 and L10. The first Rb sub-group G1Rb consists of the lens L11.

The second optical system G2 consists of, in order from the magnification side to the reduction side, the first stationary lens group G2s1 having positive refractive power, the first moving lens group G2z1 having positive refractive power, the second moving lens group G2z2 having positive refractive power, the third moving lens group G2z3 having positive refractive power, and the second stationary lens group G2s2 having positive refractive power. During a change in the magnification, the first stationary lens group G2s1 and the second stationary lens group G2s2 remain stationary with respect to the reduction-side imaging plane, and the first moving lens group G2z1, the second moving lens group G2z2, and the third moving lens group G2z3 move along the optical axis Z by changing spacings with respect to adjacent lens groups. The first stationary lens group G2s1 consists of the lens L21. The first moving lens group G2z1 consists of the lens L22. The second moving lens group G2z2 consists of the lenses L23 to L25. The third moving lens group G2z3 consists of the lenses L26 to L29. The second stationary lens group G2s2 consists of the lens L30.

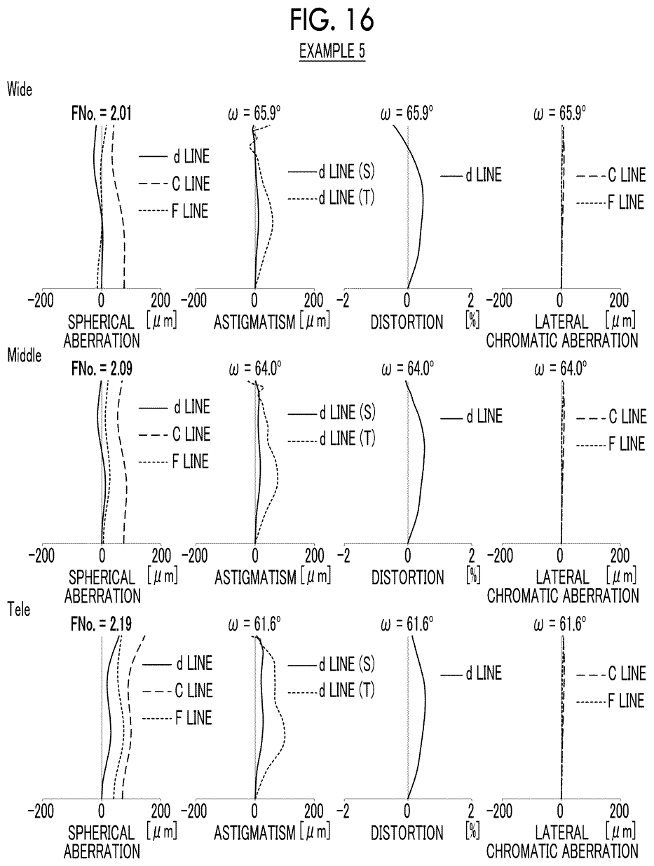

For the imaging optical system of Example 5, Tables 13A and 13B show basic lens data, Table 14 shows specifications and variable surface spacings, Table 15 shows aspherical coefficients, and FIG. 16 shows each aberration diagram. The basic lens data and each aberration diagram are shown in a state where the projection distance is 1.23 meters (m).

TABLE 13A
Example 5

| Sn | R | D | Nd | νd |
|---|---|---|---|---|
| *1 | −35.5333 | 8.9003 | 1.53638 | 56.09 |
| *2 | −147.4476 | 9.1258 | | |
| 3 | 64.5524 | 2.2491 | 1.83481 | 42.72 |
| 4 | 33.1290 | 7.6702 | | |
| 5 | 60.1742 | 1.5992 | 1.85883 | 30.00 |
| 6 | 25.3306 | 35.4176 | | |
| 7 | −21.1739 | 0.9491 | 1.94595 | 17.98 |
| 8 | −45.5517 | 0.3991 | | |
| *9 | −219.8273 | 8.0598 | 1.58913 | 61.15 |
| *10 | −22.8449 | 0.3999 | | |
| 11 | −156.0394 | 10.3952 | 1.49700 | 81.61 |
| 12 | −28.3695 | 7.9991 | | |
| 13 | 594.5962 | 1.7491 | 1.94595 | 17.98 |
| 14 | 59.3199 | 13.6824 | 1.49700 | 81.61 |
| 15 | −59.3199 | 45.7533 | | |
| 16 | 79.1011 | 13.4851 | 1.86966 | 20.02 |
| 17 | −443.9649 | 0.5010 | | |
| 18 | 39.4852 | 9.5828 | 1.92286 | 20.88 |
| 19 | 59.3982 | 18.5581 | | |
| 20 | −230.6198 | 6.0002 | 1.80518 | 25.46 |
| 21 | 38.2362 | 64.6385 | | |

TABLE 13B
Example 5

| Sn | R | D | Nd | νd |
|---|---|---|---|---|
| 22 | −220.0030 | 4.2876 | 1.86966 | 20.02 |
| 23 | −71.8517 | DD[23] | | |
| 24 | 228.7649 | 3.6102 | 1.77250 | 49.62 |
| 25 | −228.7649 | DD[25] | | |
| 26 | 40.5549 | 5.3161 | 1.86966 | 20.02 |
| 27 | 85.6970 | 4.5539 | | |
| 28 | 33.6939 | 4.1514 | 1.80420 | 46.50 |
| 29 | 45.4626 | 1.7485 | | |
| 30 | 76.2331 | 1.6945 | 1.80518 | 25.46 |
| 31 | 24.2016 | DD[31] | | |
| 32 | 308.4597 | 2.2009 | 1.94595 | 17.98 |
| 33 | 33.6529 | 0.0691 | | |
| 34 | 34.1107 | 19.0665 | 1.49700 | 81.61 |
| 35 | −22.7998 | 0.0699 | | |
| 36 | −22.6845 | 1.1991 | 1.85451 | 25.15 |
| 37 | −70.2658 | 3.1480 | | |
| 38 | −1398.1432 | 11.7836 | 1.47047 | 66.88 |
| 39 | −33.0746 | DD[39] | | |
| 40 | 157.2484 | 4.6686 | 1.92286 | 20.88 |
| 41 | −245.0361 | 22.2000 | | |
| 42 | ∞ | 42.6940 | 1.51680 | 64.20 |
| 43 | ∞ | | | |

TABLE 14
Example 5

| | Wide | Middle | Tele |
|---|---|---|---|
| Zr | 1.00 | 1.09 | 1.21 |
| \|f\| | 8.65 | 9.43 | 10.45 |
| Bf | 50.27 | 50.25 | 50.23 |
| FNo. | 2.01 | 2.09 | 2.19 |
| 2ω [°] | 131.8 | 128.0 | 123.2 |
| DD[23] | 33.3814 | 22.0054 | 8.8940 |
| DD[25] | 5.9982 | 12.2724 | 17.3748 |
| DD[31] | 14.9917 | 14.6506 | 14.8661 |
| DD[39] | 11.1622 | 16.6047 | 24.3990 |

TABLE 15
Example 5

| Sn | 1 | 2 | 9 | 10 |
|---|---|---|---|---|
| KA | −6.6621374E−01 | −1.7074165E+01 | 1.0000000E+00 | 1.0000000E+00 |
| A3 | 5.0050475E−05 | 6.0363833E−05 | 0.0000000E+00 | 0.0000000E+00 |
| A4 | 7.0292808E−05 | 6.1371962E−05 | −8.6838182E−06 | 6.9016164E−06 |
| A5 | −3.8177200E−06 | −3.0464862E−06 | 1.4355814E−07 | 6.5165457E−07 |
| A6 | 4.1330507E−08 | 2.0509516E−09 | 7.8652502E−08 | −1.6257661E−07 |
| A7 | 3.3102734E−09 | 4.7649688E−09 | −6.5889207E−09 | 1.3121700E−08 |
| A8 | −1.2044990E−10 | −1.5924255E−10 | 1.2976254E−11 | 1.2428856E−09 |
| A9 | −3.0905518E−13 | −7.1589758E−13 | 2.9114650E−11 | −2.0913638E−10 |
| A10 | 8.6509600E−14 | 1.6039303E−13 | −1.3113247E−12 | 2.8755416E−12 |
| A11 | −1.0256004E−15 | −2.4410878E−15 | −4.0861297E−14 | 8.8568019E−13 |
| A12 | −2.7312097E−17 | −6.6014669E−17 | 3.7136572E−15 | −3.6146262E−14 |
| A13 | 6.4038324E−19 | 2.1402464E−18 | 2.7388557E−17 | −1.3268929E−15 |
| A14 | 2.9579347E−21 | 5.8988055E−21 | −4.0642923E−18 | 8.3705138E−17 |
| A15 | −1.7238177E−22 | −7.7658102E−22 | −7.2693178E−21 | 2.2931405E−19 |
| A16 | 4.3220691E−25 | 3.7522117E−24 | 1.5918458E−21 | −4.3449494E−20 |
| A17 | 2.2704165E−26 | 1.3678455E−25 | | |
| A18 | −1.3916529E−28 | −1.1977537E−27 | | |
| A19 | −1.1976428E−30 | −9.4594953E−30 | | |
| A20 | 9.9858007E−33 | 1.0579073E−31 | | |

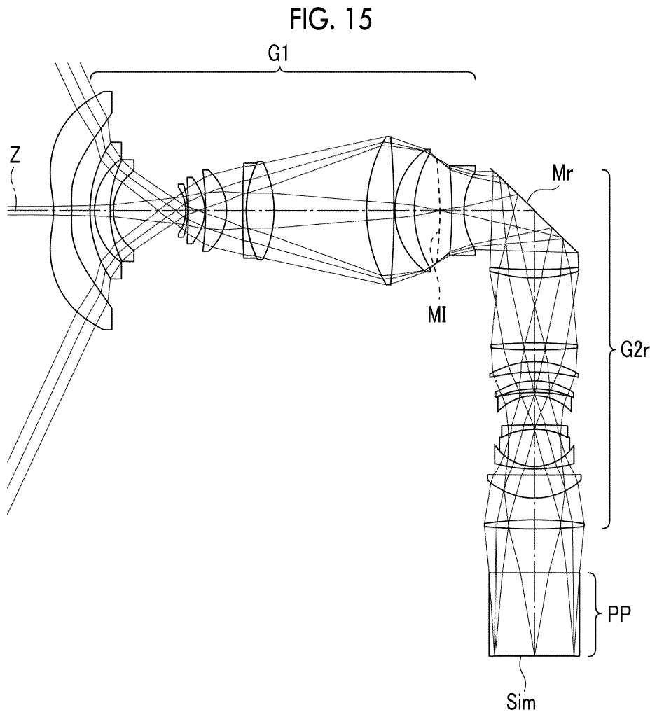

FIG. 15 shows a configuration and luminous fluxes of a modification example of Example 5 at the wide-angle end. The imaging optical system in FIG. 15 consists of, in order from the magnification side to the reduction side along the optical path, the first optical system G1 and the second optical system G2r. The second optical system G2r in FIG. 15 is different from the second optical system G2 of Example 5 in that the mirror Mr is disposed closest to the magnification side in the second optical system G2r, and the mirror Mr bends the optical path. Other configurations of the imaging optical system in FIG. 15 are the same as those of the imaging optical system of Example 5.

### Example 6

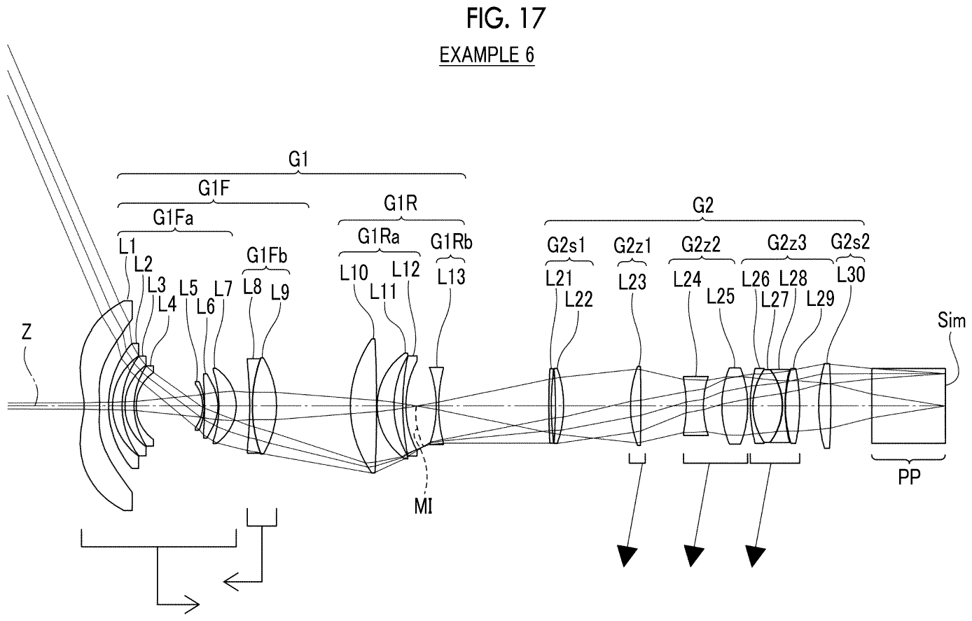

FIG. 17 shows a cross-sectional view of a configuration and luminous fluxes of an imaging optical system of Example 6. The imaging optical system of Example 6 is a zoom lens and consists of, in order from the magnification side to the reduction side, the first optical system G1 and the second optical system G2.

The first optical system G1 consists of, in order from the magnification side to the reduction side, the first F group GIF having positive refractive power, and the first R group G1R having positive refractive power. The first F group GIF is a focus group. The first F group GIF consists of, in order from the magnification side to the reduction side, the first Fa sub-group G1Fa and the first Fb sub-group G1Fb. During focusing from the short range to the long range, the first Fa sub-group G1Fa moves to the reduction side, and the first Fb sub-group G1Fb moves to the magnification side. The first R group G1R consists of, in order from the magnification side to the reduction side, the first Ra sub-group G1Ra having positive refractive power, and the first Rb sub-group G1Rb having negative refractive power. The intermediate image MI is formed between the first Ra sub-group G1Ra and the first Rb sub-group G1Rb. The first Fa sub-group G1Fa consists of the lenses L1 to L7. The first Fb sub-group G1Fb consists of the lenses L8 and L9. The first Ra sub-group G1Ra consists of the lenses L10 to L12. The first Rb sub-group G1Rb consists of the lens L13.

The second optical system G2 consists of, in order from the magnification side to the reduction side, the first stationary lens group G2s1, the first moving lens group G2z1 having positive refractive power, the second moving lens group G2z2 having negative refractive power, the third moving lens group G2z3 having negative refractive power, and the second stationary lens group G2s2 having positive refractive power. During a change in the magnification, the first stationary lens group G2s1 and the second stationary lens group G2s2 remain stationary with respect to the reduction-side imaging plane, and the first moving lens group G2z1, the second moving lens group G2z2, and the third moving lens group G2z3 move along the optical axis Z by changing spacings with respect to adjacent lens groups. The first stationary lens group G2s1 consists of the lenses L21 and L22. The first moving lens group G2z1 consists of the lens L23. The second moving lens group G2z2 consists of the lenses L24 and L25. The third moving lens group G2z3 consists of the lenses L26 to L29. The second stationary lens group G2s2 consists of the lens L30.

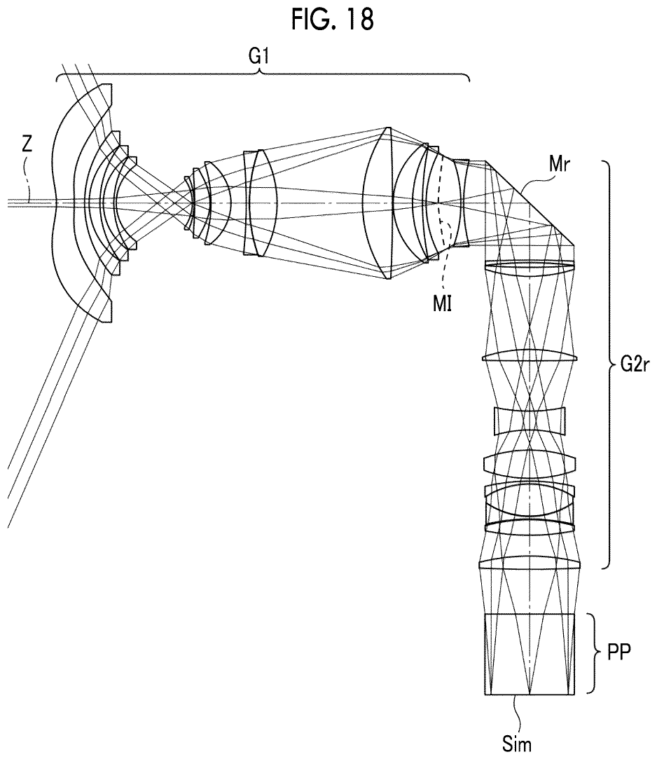

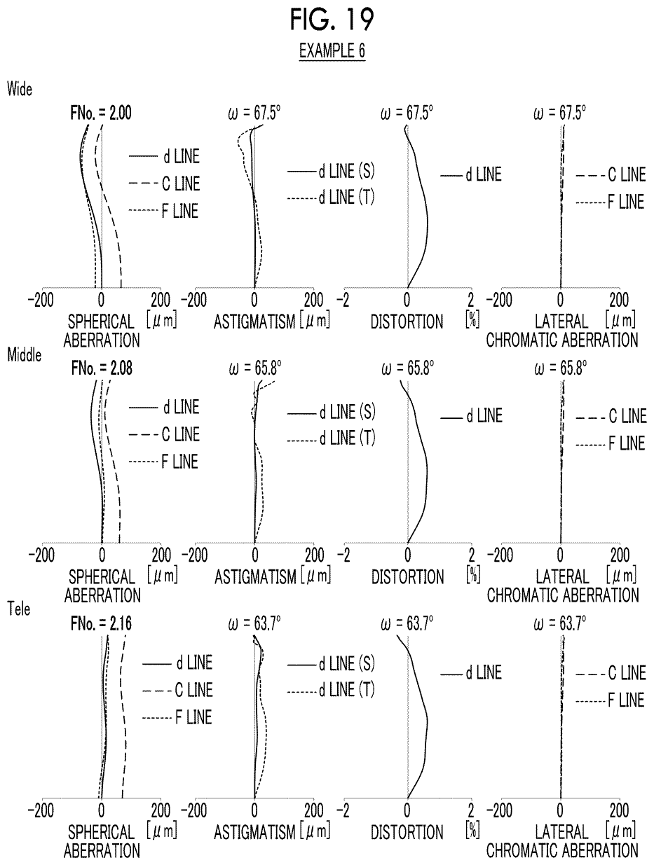

For the imaging optical system of Example 6, Tables 16A and 16B show basic lens data, Table 17 shows specifications and variable surface spacings, Table 18 shows aspherical coefficients, and FIG. 19 shows each aberration diagram. The basic lens data and each aberration diagram are shown in a state where the projection distance is 1.13 meters (m).

TABLE 16A
Example 6

| Sn | R | D | Nd | νd |
|---|---|---|---|---|
| *1 | −31.1730 | 9.0009 | 1.53638 | 56.09 |
| *2 | −76.7304 | 5.1784 | | |
| 3 | 59.4004 | 2.3005 | 1.83481 | 42.72 |
| 4 | 37.7866 | 5.4668 | | |
| 5 | 51.0744 | 1.7005 | 1.83481 | 42.72 |
| 6 | 30.6725 | 5.3254 | | |
| 7 | 44.5716 | 1.1992 | 1.83481 | 42.72 |
| 8 | 25.4181 | 38.4677 | | |
| 9 | −22.5827 | 0.9003 | 1.94595 | 17.98 |
| 10 | −36.4555 | 0.1995 | | |
| *11 | −209.7840 | 7.7766 | 1.58913 | 61.15 |
| *12 | −25.0289 | 0.5010 | | |
| 13 | −71.9030 | 10.0813 | 1.49700 | 81.61 |
| 14 | −27.6436 | 7.7200 | | |
| 15 | −267.8023 | 1.5997 | 1.94595 | 17.98 |
| 16 | 88.2555 | 13.9619 | 1.59282 | 68.62 |
| 17 | −58.9936 | 42.8148 | | |
| 18 | 72.0215 | 15.1665 | 1.86966 | 20.02 |
| 19 | −893.8351 | 0.3004 | | |
| 20 | 39.6938 | 9.7662 | 1.94595 | 17.98 |
| 21 | 61.0938 | 5.0505 | | |
| 22 | 152.4109 | 1.8008 | 1.83481 | 42.72 |
| 23 | 60.2409 | 17.5918 | | |
| 24 | −71.8740 | 1.3991 | 1.59282 | 68.62 |
| 25 | 92.1250 | 63.4188 | | |

TABLE 16B
Example 6

| Sn | R | D | Nd | νd |
|---|---|---|---|---|
| 26 | 439.6366 | 1.3991 | 1.94595 | 17.98 |
| 27 | 175.5487 | 2.4448 | | |
| 28 | −290.2606 | 4.7363 | 1.84666 | 23.78 |
| 29 | −70.7120 | DD[29] | | |
| 30 | 71.2523 | 6.0073 | 2.00100 | 29.13 |
| 31 | −1218.2141 | DD[31] | | |
| 32 | −80.4924 | 10.0001 | 1.83481 | 42.72 |
| 33 | 58.4641 | 10.6212 | | |
| 34 | 62.9580 | 14.9592 | 1.49700 | 81.61 |
| 35 | −64.7913 | DD[35] | | |
| 36 | 92.5041 | 1.4991 | 1.86966 | 20.02 |
| 37 | 40.3443 | 0.0340 | | |
| 38 | 40.4887 | 16.8910 | 1.59282 | 68.62 |
| 39 | −37.9116 | 0.2625 | | |
| 40 | −37.0191 | 1.3998 | 1.80518 | 25.46 |
| 41 | 93.1183 | 0.2991 | | |
| 42 | 80.9689 | 8.1983 | 1.52501 | 70.33 |
| 43 | −110.6276 | DD[43] | | |
| 44 | 99.4116 | 6.9999 | 1.94595 | 17.98 |
| 45 | −498.9884 | 23.7000 | | |
| 46 | ∞ | 42.6940 | 1.51680 | 64.20 |
| 47 | ∞ | | | |

TABLE 17
Example 6

| | Wide | Middle | Tele |
|---|---|---|---|
| Zr | 1.00 | 1.09 | 1.20 |
| \|f\| | 7.97 | 8.68 | 9.55 |
| Bf | 51.79 | 51.77 | 51.77 |
| FNo. | 2.00 | 2.08 | 2.16 |
| 2ω [°] | 135.0 | 131.6 | 127.4 |
| DD[29] | 38.6801 | 29.5507 | 19.7871 |
| DD[31] | 26.2656 | 26.9801 | 28.2952 |
| DD[35] | 1.5000 | 3.6662 | 5.3414 |
| DD[43] | 11.0233 | 17.2700 | 24.0461 |

TABLE 18
Example 6

| Sn | 1 | 2 | 11 | 12 |
|---|---|---|---|---|
| KA | −1.5661760E+00 | 1.6811117E+00 | 1.0000000E+00 | 1.0000000E+00 |
| A3 | 8.4039344E−05 | 5.9671819E−05 | 0.0000000E+00 | 0.0000000E+00 |
| A4 | 6.5675978E−05 | 6.7046639E−05 | −4.5122516E−06 | 1.0182650E−05 |
| A5 | −3.7009998E−06 | −3.2747175E−06 | 3.7455918E−07 | −1.7079203E−07 |
| A6 | 3.6377997E−08 | −5.4061395E−09 | 7.7876440E−09 | 1.3727571E−08 |
| A7 | 3.3031931E−09 | 5.4446971E−09 | −8.2231647E−10 | 3.2691926E−09 |
| A8 | −1.0687842E−10 | −1.5334116E−10 | 1.4771368E−12 | −7.5900117E−11 |
| A9 | −6.0636704E−13 | −1.8134749E−12 | 1.3844508E−12 | −2.9426049E−11 |
| A10 | 7.6394648E−14 | 1.6631105E−13 | −2.1221928E−14 | 2.5041695E−12 |
| A11 | −6.6051008E−16 | −1.5067990E−15 | −9.2836062E−16 | 2.3755570E−14 |
| A12 | −2.4754157E−17 | −7.8270243E−17 | 2.7974936E−17 | −9.9513192E−15 |
| A13 | 4.4721050E−19 | 1.6981027E−18 | 3.1021120E−19 | 2.9213831E−16 |
| A14 | 3.3191394E−21 | 1.3952051E−20 | −1.4737360E−20 | 9.1796091E−18 |
| A15 | −1.1943909E−22 | −6.6008815E−22 | −4.1510847E−23 | −6.2779100E−19 |
| A16 | 1.0257686E−25 | 1.1584404E−24 | 2.7886297E−24 | 9.3354170E−21 |
| A17 | 1.5304759E−26 | 1.2073466E−25 | | |
| A18 | −7.4277326E−29 | −7.7988775E−28 | | |
| A19 | −7.7864313E−31 | −8.5660486E−30 | | |
| A20 | 5.6335899E−33 | 7.8947452E−32 | | |

FIG. 18 shows a configuration and luminous fluxes of a modification example of Example 6 at the wide-angle end. The imaging optical system in FIG. 18 consists of, in order from the magnification side to the reduction side along the optical path, the first optical system G1 and the second optical system G2r. The second optical system G2r in FIG. 18 is different from the second optical system G2 of Example 6 in that the mirror Mr is disposed closest to the magnification side in the second optical system G2r, and the mirror Mr bends the optical path. Other configurations of the imaging optical system in FIG. 18 are the same as those of the imaging optical system of Example 6.

### Example 7

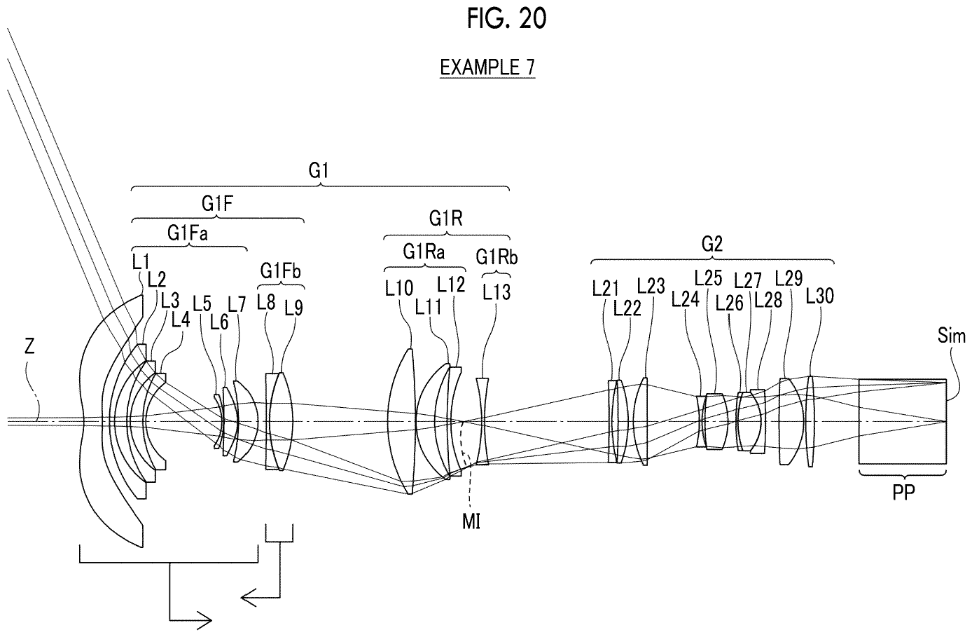

FIG. 20 shows a cross-sectional view of a configuration and luminous fluxes of an imaging optical system of Example 7. The imaging optical system of Example 7 is a fixed focal point optical system and consists of, in order from the magnification side to the reduction side, the first optical system G1 and the second optical system G2.

The first optical system G1 consists of, in order from the magnification side to the reduction side, the first F group GIF having positive refractive power, and the first R group G1R having positive refractive power. The first F group GIF is a focus group. The first F group G1F consists of, in order from the magnification side to the reduction side, the first Fa sub-group G1Fa and the first Fb sub-group G1Fb. During focusing from the short range to the long range, the first Fa sub-group G1Fa moves to the reduction side, and the first Fb sub-group G1Fb moves to the magnification side. The first R group G1R consists of, in order from the magnification side to the reduction side, the first Ra sub-group G1Ra having positive refractive power, and the first Rb sub-group G1Rb having negative refractive power. The intermediate image MI is formed between the first Ra sub-group G1Ra and the first Rb sub-group G1Rb. The first Fa sub-group G1Fa consists of the lenses L1 to L7. The first Fb sub-group G1Fb consists of the lenses L8 and L9. The first Ra sub-group G1Ra consists of the lenses L10 to L12. The first Rb sub-group G1Rb consists of the lens L13. The second optical system G2 consists of, in order from the magnification side to the reduction side, the lenses L21 to L30.

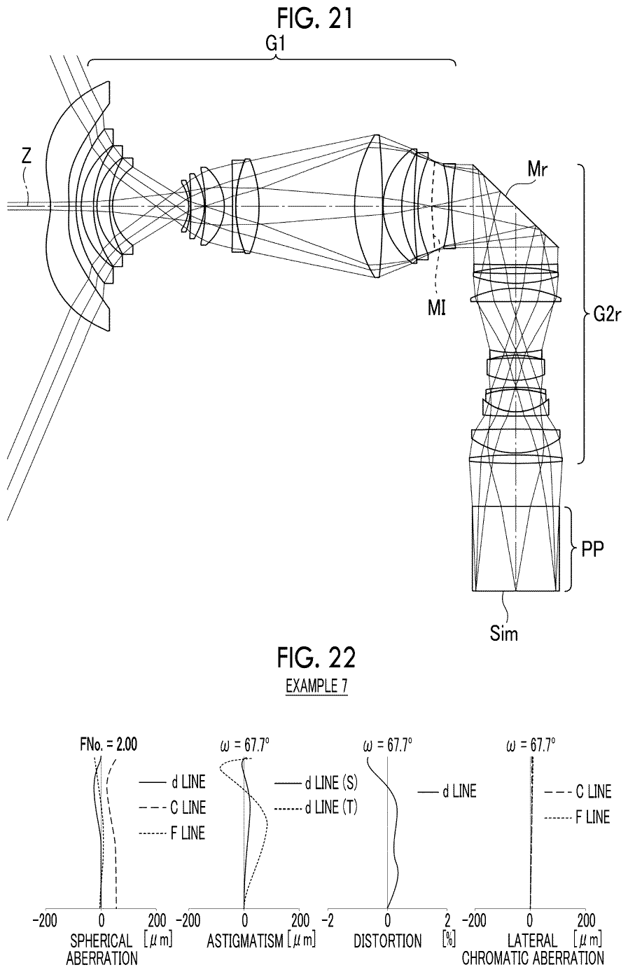

For the imaging optical system of Example 7, Tables 19A and 19B show basic lens data, Table 20 shows specifications, Table 21 shows aspherical coefficients, and FIG. 22 shows each aberration diagram. A value in a lowermost field of D in Table 19B is a spacing between a surface closest to the reduction side in the table and the image display surface Sim. The basic lens data and each aberration diagram are shown in a state where the projection distance is 1.13 meters (m).

TABLE 19A
Example 7

| Sn | R | D | Nd | νd |
|---|---|---|---|---|
| *1 | −29.2032 | 9.0000 | 1.53638 | 56.09 |
| *2 | −77.8973 | 3.4027 | | |
| 3 | 61.6307 | 2.5456 | 1.83481 | 42.72 |
| 4 | 38.3688 | 5.9713 | | |
| 5 | 52.9161 | 1.7008 | 1.83481 | 42.72 |
| 6 | 30.6268 | 6.1209 | | |
| 7 | 49.1867 | 1.4608 | 1.83481 | 42.72 |
| 8 | 24.7098 | 37.1642 | | |
| 9 | −21.7149 | 0.9009 | 1.94595 | 17.98 |
| 10 | −38.2726 | 0.2009 | | |
| *11 | −207.5815 | 6.5364 | 1.58913 | 61.15 |
| *12 | −24.7701 | 0.5008 | | |
| 13 | −80.9483 | 9.2533 | 1.49700 | 81.61 |
| 14 | −25.9568 | 3.9998 | | |
| 15 | −1094.3789 | 1.6001 | 1.94595 | 17.98 |
| 16 | 64.1875 | 11.3643 | 1.59282 | 68.62 |
| 17 | −64.9537 | 46.3510 | | |
| 18 | 70.8088 | 13.5899 | 1.86966 | 20.02 |
| 19 | −413.3199 | 0.3009 | | |
| 20 | 36.3747 | 9.0937 | 1.94595 | 17.98 |
| 21 | 54.3346 | 6.1132 | | |
| 22 | 263.4614 | 1.8003 | 1.83481 | 42.72 |
| 23 | 62.6986 | 15.0478 | | |
| 24 | −88.9511 | 1.4007 | 1.59282 | 68.62 |
| 25 | 117.1306 | 60.8470 | | |

TABLE 19B
Example 7

| Sn | R | D | Nd | νd |
|---|---|---|---|---|
| 26 | −754.9553 | 1.3991 | 1.59270 | 35.31 |
| 27 | 88.3064 | 3.0804 | | |
| 28 | −411.5377 | 4.9236 | 1.80518 | 25.46 |
| 29 | −63.1118 | 2.5007 | | |
| 30 | 50.4029 | 6.7115 | 2.00100 | 29.13 |
| 31 | 10484.4372 | 25.5303 | | |
| 32 | −58.3889 | 1.2992 | 1.72342 | 37.95 |
| 33 | 40.0854 | 1.4368 | | |
| 34 | 110.8544 | 11.2074 | 1.49700 | 81.61 |
| 35 | −36.3064 | 3.5905 | | |
| 36 | 94.4607 | 1.0001 | 1.94595 | 17.98 |
| 37 | 45.2508 | 0.0691 | | |
| 38 | 45.9315 | 11.2489 | 1.49700 | 81.61 |
| 39 | −23.2130 | 0.0707 | | |
| 40 | −23.0501 | 2.1539 | 1.86966 | 20.02 |
| 41 | −247.9585 | 6.5786 | | |
| 42 | 496.1534 | 12.0621 | 1.51860 | 69.89 |
| 43 | −35.1276 | 1.0000 | | |
| 44 | 180.2445 | 4.2325 | 1.94595 | 17.98 |
| 45 | −242.5931 | 21.7681 | | |
| 46 | ∞ | 42.6940 | 1.51680 | 64.20 |
| 47 | ∞ | 0.0297 | | |

TABLE 20
Example 7

| | |
|---|---|
| \|f\| | 7.95 |
| Bf | 49.89 |
| FNo. | 2.00 |
| 2ω [°] | 135.4 |

TABLE 21
Example 7

| Sn | 1 | 2 | 11 | 12 |
|---|---|---|---|---|
| KA | −1.5022534E+00 | 1.6721044E+00 | 1.0000000E+00 | 1.0000000E+00 |
| A3 | 1.1249826E−04 | 1.0782271E−04 | 1.8483188E−21 | 4.1450525E−20 |
| A4 | 6.8718509E−05 | 6.2929136E−05 | −5.2348953E−06 | 9.1740881E−06 |
| A5 | −3.9371742E−06 | −2.9222679E−06 | 2.6660679E−07 | 2.9653174E−07 |
| A6 | 4.3019047E−08 | 9.6374432E−09 | 3.5392302E−08 | −2.4528505E−08 |
| A7 | 3.4538212E−09 | 3.9200611E−09 | −9.1202922E−10 | −7.1892276E−10 |
| A8 | −1.2295382E−10 | −1.6995785E−10 | −1.7947790E−10 | 4.8007200E−10 |
| A9 | −4.0207232E−13 | 9.5333831E−13 | 5.0211166E−12 | −9.2226204E−12 |
| A10 | 8.8324739E−14 | 1.6070462E−13 | 5.4820955E−13 | −8.9456726E−13 |
| A11 | −9.8387477E−16 | −4.1713733E−15 | −1.8487605E−14 | −3.4085621E−14 |
| A12 | −2.8045742E−17 | −5.4502678E−17 | −5.8675839E−16 | 1.4507651E−15 |
| A13 | 6.2490246E−19 | 3.1640108E−18 | 3.3534349E−17 | 3.7864380E−16 |
| A14 | 3.1582354E−21 | −5.4031163E−21 | −8.4441604E−19 | −1.0807212E−17 |
| A15 | −1.6804250E−22 | −1.1193058E−21 | −2.3121448E−20 | −6.8044696E−19 |
| A16 | 3.9019548E−25 | 8.5925375E−24 | 1.7024219E−21 | 2.3321299E−20 |
| A17 | 2.1981429E−26 | 1.9691048E−25 | | |
| A18 | −1.3307761E−28 | −2.1920892E−27 | | |
| A19 | −1.1468712E−30 | −1.3734616E−29 | | |
| A20 | 9.5761320E−33 | 1.8564724E−31 | | |

FIG. 21 shows a configuration and luminous fluxes of a modification example of Example 7 at the wide-angle end. The imaging optical system in FIG. 21 consists of, in order from the magnification side to the reduction side along the optical path, the first optical system G1 and the second optical system G2r. The second optical system G2r in FIG. 21 is different from the second optical system G2 of Example 7 in that the mirror Mr is disposed closest to the magnification side in the second optical system G2r, and the mirror Mr bends the optical path. Other configurations of the imaging optical system in FIG. 21 are the same as those of the imaging optical system of Example 7.

Table 22 shows the corresponding values of Conditional Expressions (1) to (15) of the imaging optical system of Examples 1 to 7. In Table 22, a reference numeral of the positive lens of the second optical system satisfying Conditional Expressions (7), (8), and (9) is shown in a row of “(7) (8) (9)”, and the corresponding values of Conditional Expressions (7), (8), and (9) of the lens are shown in rows of “(7)”, “(8)”, and “(9)”, respectively. Similarly, a reference numeral of the positive lens closest to the magnification side among the positive lenses included in the first Ra sub-group G1Ra is shown in a row of “(12) (13)”, and the corresponding values of Conditional Expressions (12) and (13) of the lens are shown in rows of “(12)” and “(13)”, respectively. In the row of “(7) (8) (9)”, a material of the lens L27 of Examples 1, 2, and 7 is J-PKH1 manufactured by Hikari Glass Co., Ltd. A material of the lens L27 of Example 5 is H-QK1 manufactured by CDGM Co., Ltd. A material of the lens L27 of Example 6 is K-PMK30 manufactured by Sumita Optical Glass, Inc.

TABLE 22

| Expression | | | | | | | | |
|---|---|---|---|---|---|---|---|---|
| Number | | Example 1 | Example 2 | Example 3 | Example 4 | Example 5 | Example 6 | Example 7 |
| (1) | Dair/DAL | 0.16 | 0.15 | 0.16 | 0.15 | 0.16 | 0.15 | 0.17 |
| (2) | DG1/DG2 | 1.63 | 1.68 | 1.55 | 1.54 | 1.52 | 1.26 | 1.95 |
| (3) | \|fz1/fz2\| | 0.325 | 0.384 | 0.343 | −0.414 | 0.296 | −0.247 | |
| (4) | \|fz1/fz3\| | 0.607 | 0.546 | 0.633 | 0.056 | 0.539 | −0.056 | |
| (5) | \|f1/f\| | 0.97 | 0.87 | 0.98 | 0.95 | 1.04 | 1.16 | 0.91 |
| (6) | \|f1/f2\| | 0.076 | 0.083 | 0.073 | 0.095 | 0.062 | 0.066 | 0.091 |
| (10) | f1F/f1R | 0.367 | 0.331 | 0.401 | 0.442 | 0.398 | 0.35 | 0.393 |
| (11) | f1Ra/f1Rb | −0.893 | −0.82 | −1.115 | −0.692 | −1.094 | −0.793 | −0.594 |
| (14) | N2r | 1.86966 | 1.86966 | 1.86966 | 1.86966 | 1.92286 | 1.94595 | 1.94595 |
| (15) | ν2r | 20.02 | 20.02 | 20.02 | 20.02 | 20.88 | 17.98 | 17.98 |
| (7) (8) (9) | | L27 | L27 | | | L27 | L27 | L27 |
| (7) | N2p | 1.51860 | 1.51860 | | | 1.47047 | 1.52501 | 1.51860 |
| (8) | ν2p | 69.89 | 69.89 | | | 66.88 | 70.33 | 69.89 |
| (9) | dN2p/dT | 3.6 | 3.6 | | | 0.2 | 2.0 | 3.6 |
| (12) (13) | | L9 | L9 | L9 | L9 | L9 | L10 | L10 |
| (12) | NRap | 1.86966 | 1.86966 | 1.86966 | 1.86966 | 1.86966 | 1.86966 | 1.86966 |
| (13) | νRap | 20.02 | 20.02 | 20.02 | 20.02 | 20.02 | 20.02 | 20.02 |

The imaging optical system of Examples 1 to 7 is an optical system that forms an intermediate image, and is configured to be reduced in size while having an appropriate air spacing. In addition, the imaging optical system of Examples 1 to 7 has a maximum half angle of view of 60 degrees or more, has a wide angle of view, and furthermore, implements high optical performance by favorably correcting each aberration.

A projection optical system used in a projection type display device is required to perform favorable aberration correction corresponding to resolution of a light valve of the projection type display device while having a wide angle. In addition, ability to perform projection with a large screen size from a position close to a screen is also required. An ultra-short focal point lens system is considered to meet such requirement. However, considering reduction of an increase in a diameter of a lens and its feasibility, a lens system that forms an intermediate image is more suitable. The lens system having the intermediate image has a long total length. Thus, it may be required to bend the optical path to reduce the length. However, appropriate selection of a bending position or a lens shape is desired. As shown in the modification examples, the imaging optical system of the present disclosure is also suitably applicable to a configuration in which the optical path is bent.

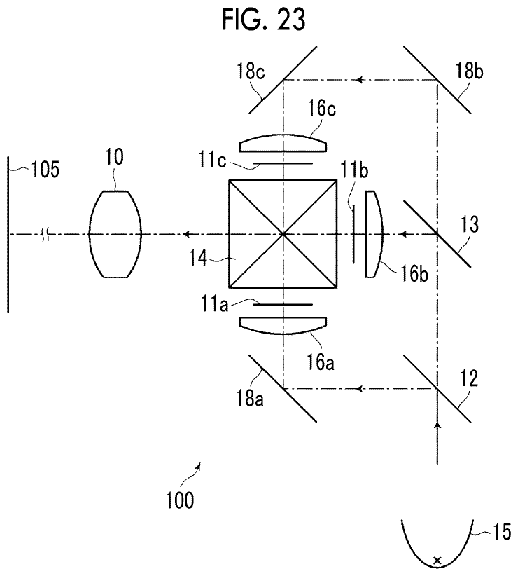

Next, a projection type display device according to an embodiment of the present disclosure will be described. FIG. 23 is a schematic configuration diagram of the projection type display device according to an embodiment of the present disclosure. A projection type display device 100 shown in FIG. 23 includes an imaging optical system 10 according to the embodiment of the present disclosure, a light source 15, and transmissive type display elements 11a to 11c as light valves outputting an optical image in accordance with each color light. In addition, the projection type display device 100 includes dichroic mirrors 12 and 13 for color separation, a cross-dichroic prism 14 for color combination, condenser lenses 16a to 16c, and total reflection mirrors 18a to 18c for deflecting the optical path. In FIG. 23, the imaging optical system 10 is schematically shown. In addition, while an integrator is disposed between the light source 15 and the dichroic mirror 12, the integrator is not shown in FIG. 23.

White light from the light source 15 is separated into three color luminous fluxes (blue light, green light, and red light) by the dichroic mirrors 12 and 13. Then, the color luminous fluxes are incident on and modulated by the transmissive type display elements 11a to 11c corresponding to each color luminous flux through the condenser lenses 16a to 16c, respectively. The color luminous fluxes are combined by the cross-dichroic prism 14 and are then incident on the imaging optical system 10. The imaging optical system 10 projects, to a screen 105, an optical image based on the modulated light modulated by the transmissive type display elements 11a to 11c.

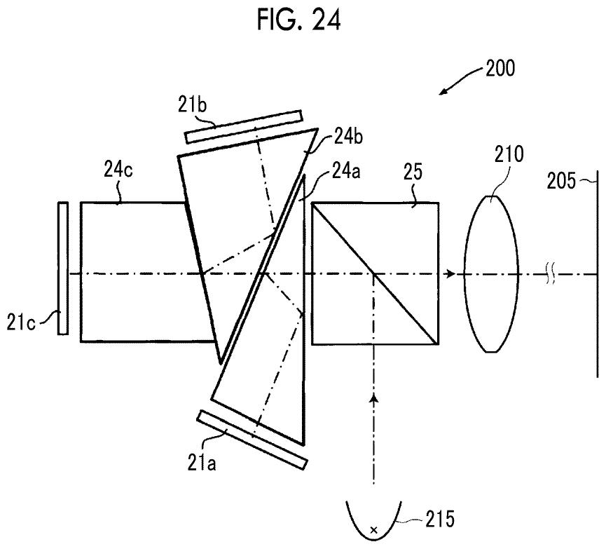

FIG. 24 is a schematic configuration diagram of a projection type display device according to another embodiment of the present disclosure. A projection type display device 200 shown in FIG. 24 includes an imaging optical system 210 according to the embodiment of the present disclosure, a light source 215, and digital micromirror device (DMD; registered trademark) elements 21a to 21c as light valves that output an optical image in accordance with each color light. In addition, the projection type display device 200 includes total internal reflection (TIR) prisms 24a to 24c for color separation and color combination, and a polarization separating prism 25 that separates illumination light and projection light from each other. In FIG. 24, the imaging optical system 210 is schematically shown. In addition, while an integrator is disposed between the light source 215 and the polarization separating prism 25, the integrator is not shown in FIG. 24.

White light from the light source 215 is reflected by a reflecting surface in the polarization separating prism 25, and is separated into three color luminous fluxes (blue light, green light, and red light) by the TIR prisms 24a to 24c. Each color luminous flux after separation is incident on and modulated by the corresponding DMD elements 21a to 21c, travels through the TIR prisms 24a to 24c again in a reverse direction to be combined, and is then transmitted through the polarization separating prism 25 to be incident on the imaging optical system 210. The imaging optical system 210 projects, to a screen 205, an optical image based on the modulated light modulated by the DMD elements 21a to 21c.

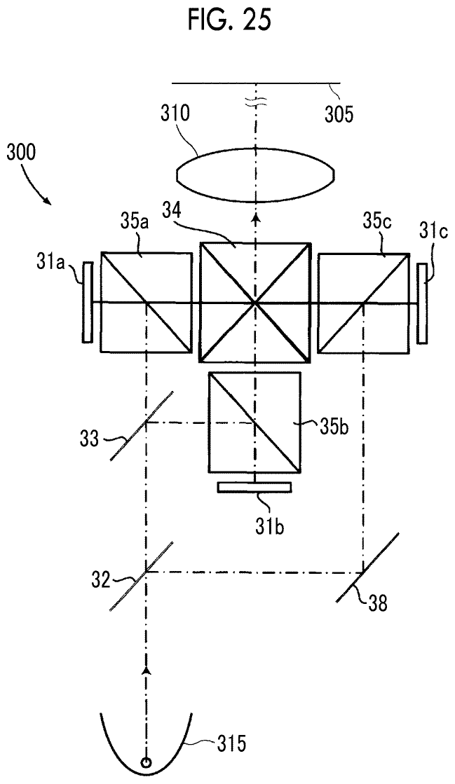

FIG. 25 is a schematic configuration diagram of a projection type display device according to still another embodiment of the present disclosure. A projection type display device 300 shown in FIG. 25 includes an imaging optical system 310 according to the embodiment of the present disclosure, a light source 315, and reflective type display elements 31a to 31c as light valves that output an optical image in accordance with each color light. In addition, the projection type display device 300 includes dichroic mirrors 32 and 33 for color separation, a cross-dichroic prism 34 for color combination, a total reflection mirror 38 for optical path deflection, and polarization separating prisms 35a to 35c. In FIG. 25, the imaging optical system 310 is schematically shown. In addition, while an integrator is disposed between the light source 315 and the dichroic mirror 32, the integrator is not shown in FIG. 25.

White light from the light source 315 is separated into three color luminous fluxes (blue light, green light, and red light) by the dichroic mirrors 32 and 33. Each color luminous flux after separation is incident on and modulated by the reflective type display elements 31a to 31c corresponding to each color luminous flux through the polarization separating prisms 35a to 35c, is combined by the cross-dichroic prism 34, and is then incident on the imaging optical system 310. The imaging optical system 310 projects, to a screen 305, an optical image based on the modulated light modulated by the reflective display elements 31a to 31c.

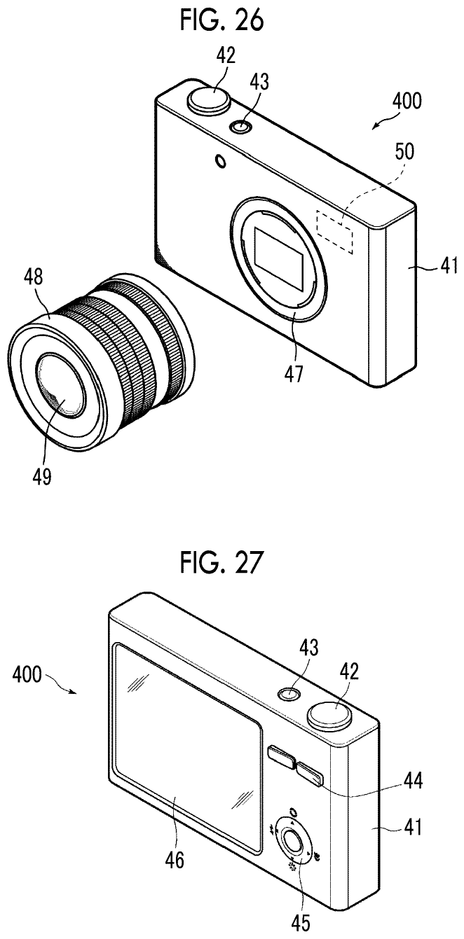

FIGS. 26 and 27 are external views showing a camera 400 that is an imaging apparatus according to an embodiment of the present disclosure. FIG. 26 is a perspective view of the camera 400 seen from a front surface side, and FIG. 27 is a perspective view of the camera 400 seen from a rear surface side. The camera 400 is a mirrorless type single-lens digital camera on which an interchangeable lens 48 is attachably and detachably mounted. In the interchangeable lens 48, an imaging optical system 49 according to the embodiment of the present disclosure is accommodated in a lens barrel.

The camera 400 comprises a camera body 41. A shutter button 42 and a power button 43 are provided on an upper surface of the camera body 41. In addition, an operation unit 44, an operation unit 45, and a display unit 46 are provided on a rear surface of the camera body 41. The display unit 46 displays a captured image and an image within an angle of view before imaging.

An imaging aperture on which light from an imaging target is incident is provided in a center portion on a front surface of the camera body 41. A mount 47 is provided at a position corresponding to the imaging aperture. The interchangeable lens 48 is mounted on the camera body 41 via the mount 47.

An imaging element 50 is provided in the camera body 41. The imaging element 50 outputs an imaging signal corresponding to a subject image formed by the interchangeable lens 48. For example, a charge coupled device (CCD) or a complementary metal oxide semiconductor (CMOS) is used as the imaging element 50. A signal processing circuit (not shown), a recording medium (not shown), and the like are provided in the camera body 41. The signal processing circuit processes the imaging signal output from the imaging element 50 to generate an image. The recording medium is used for recording the generated image. The camera 400 can capture a still image or a video by pressing the shutter button 42, and image data obtained by imaging is recorded on the recording medium.

While the disclosed technology is described above using embodiments and examples, the disclosed technology is not limited to the embodiments and the examples, and various modifications can be made. For example, a curvature radius, a surface spacing, a refractive index, an Abbe number, and aspherical coefficients of each lens are not limited to the values shown in each example and may have other values.

The projection type display device according to the disclosed technology is also not limited to the above configuration, and can adopt various aspects of, for example, the optical member and the light valve used for luminous flux separation or luminous flux combination. The light valve is not limited to an aspect of spatially modulating light from a light source via an image display element and outputting the light as an optical image based on image data, and may adopt an aspect of outputting light itself output from a self-emissive type image display element as an optical image based on image data. Examples of the self-emissive type image display element include an image display element in which light-emitting elements such as light-emitting diodes (LED) or organic light-emitting diodes (OLED) are two-dimensionally arranged.

The imaging apparatus according to the disclosed technology is also not limited to the above configuration, and can adopt various aspects such as a camera of a type other than a mirrorless type, a film camera, a video camera, a security camera, and a movie imaging camera.

The following appendices are further disclosed with respect to the embodiments and the examples described above.

### Appendix 1

An imaging optical system that
conjugates a reduction-side imaging plane and a magnification-side imaging plane each other,
forms, in the imaging optical system, an intermediate image at a position conjugate to the magnification-side imaging plane, and
consists of, in order from a magnification side to a reduction side along an optical path, a first optical system and a second optical system,
in which the first optical system and the second optical system are separated by a maximum air spacing among air spacings between lenses on an optical axis on the reduction side with respect to the intermediate image,
the first optical system includes a lens surface having a concave shape adjacent to the intermediate image on the magnification side, and a lens surface having a concave shape adjacent to the intermediate image on the reduction side,
a lens surface of the first optical system closest to the reduction side has a concave shape, and
in a case where an air spacing on the optical axis between the first optical system and the second optical system is denoted by Dair,
a distance on the optical axis from a lens surface of the first optical system closest to the magnification side to a lens surface of the second optical system closest to the reduction side is denoted by DAL,
a distance on the optical axis from the lens surface of the first optical system closest to the magnification side to the lens surface of the first optical system closest to the reduction side is denoted by DG1,
a distance on the optical axis from a lens surface of the second optical system closest to the magnification side to the lens surface of the second optical system closest to the reduction side is denoted by DG2, and
in a case where the imaging optical system is a variable magnification optical system, Dair, DAL, DG1, and DG2 are values at a wide-angle end,
Conditional Expressions (1) and (2) are satisfied, which are represented by

$$0.11 < Dair / DAL < 0.25 and \qquad ( 1 )$$

$$1 < DG 1 / DG 2 < 2.4 . \qquad ( 2 )$$

### Appendix 2

The imaging optical system according to Appendix 1,
in which a maximum half angle of view is 45 degrees or more, and
in a case where the imaging optical system is a variable magnification optical system, the maximum half angle of view is a value at the wide-angle end.

### Appendix 3

The imaging optical system according to Appendix 1 or 2,
in which the lens surface of the second optical system closest to the magnification side has a concave shape.

### Appendix 4

The imaging optical system according to any one of Appendices 1 to 3,
in which the imaging optical system is a zoom lens in which a moving lens group that moves during a change in magnification is included in the second optical system.

### Appendix 5

The imaging optical system according to Appendix 4,
in which the second optical system includes, in consecutive order from the magnification side to the reduction side along the optical path, a first moving lens group having positive refractive power, a second moving lens group having refractive power, and a third moving lens group having refractive power, and
during a change in the magnification, a spacing between the first moving lens group and the second moving lens group changes, and a spacing between the second moving lens group and the third moving lens group changes.

### Appendix 6

The imaging optical system according to Appendix 5,
in which each of the second moving lens group and the third moving lens group has positive refractive power.

### Appendix 7

The imaging optical system according to Appendix 5 or 6,
in which in a case where a focal length of the first moving lens group is denoted by fz1, and
a focal length of the second moving lens group is denoted by fz2,
Conditional Expression (3) is satisfied, which is represented by

$$0 < \vert fz 1 / fz 2 \vert < 1. \qquad ( 3 )$$

### Appendix 8

The imaging optical system according to any one of Appendices 5 to 7,
in which in a case where a focal length of the first moving lens group is denoted by fz1, and
a focal length of the third moving lens group is denoted by fz3,
Conditional Expression (4) is satisfied, which is represented by

$$0 < \vert fz 1 / fz 3 \vert < 1.5 . \qquad ( 4 )$$

### Appendix 9

The imaging optical system according to any one of Appendices 4 to 8,
in which a lens closest to the magnification side in the second optical system remains stationary with respect to the reduction-side imaging plane during a change in the magnification.

### Appendix 10

The imaging optical system according to any one of Appendices 1 to 9,
in which the second optical system includes, closest to the magnification side, an optical path bending member that bends the optical path.

### Appendix 11

The imaging optical system according to any one of Appendices 1 to 10,
in which in a case where a focal length of the first optical system is denoted by f1,
a focal length of the imaging optical system is denoted by f, and
in a case where the imaging optical system is a variable magnification optical system, f1 and f are values at the wide-angle end,

Conditional Expression (5) is satisfied, which is represented by

$$0.7 < \vert f 1 / f \vert < 1.4 . \qquad ( 5 )$$

### Appendix 12

The imaging optical system according to any one of Appendices 1 to 11,
in which in a case where a focal length of the first optical system is denoted by f1,
a focal length of the second optical system is denoted by f2, and
in a case where the imaging optical system is a variable magnification optical system, f1 and f2 are values at the wide-angle end,
Conditional Expression (6) is satisfied, which is represented by

$$0.01 < \vert f 1 / f 2 \vert < 0.25 . \qquad ( 6 )$$

### Appendix 13

The imaging optical system according to any one of Appendices 1 to 12,
in which the second optical system includes at least one positive lens, and
in a case where a refractive index of the positive lens of the second optical system at a d line is denoted by N2p,
an Abbe number of the positive lens of the second optical system at the d line is denoted by v2p,
a temperature coefficient, at a temperature of 20° C., of the refractive index of the positive lens of the second optical system at the d line is denoted by (dN2p/dT)×10⁻⁶, and
a unit of dN2p/dT is ° C.⁻¹,
the second optical system includes at least one positive lens satisfying Conditional Expressions (7), (8), and (9) represented by

$$1.4 < N 2 p < 1.55 , \qquad ( 7 )$$

$$66 < v 2 p < 100 , and \qquad ( 8 )$$

$$0 < dN 2 p / dT < 10. \qquad ( 9 )$$

### Appendix 14

The imaging optical system according to any one of Appendices 1 to 13,
in which the first optical system consists of, in order from the magnification side to the reduction side along the optical path, a first F group and a first R group that are separated by a maximum air spacing on the optical axis in the first optical system,
the intermediate image is formed in the first R group, and
in a case where a focal length of the first F group is denoted by f1F,
a focal length of the first R group is denoted by f1R, and
in a case where the imaging optical system is a variable magnification optical system, f1F and f1R are values at the wide-angle end,
Conditional Expression (10) is satisfied, which is represented by

$$0.25 < f 1 F / f 1 R < 0.75 . \qquad ( 10 )$$

### Appendix 15

The imaging optical system according to Appendix 14,
in which the first R group consists of, in order from the magnification side to the reduction side along the optical path, a first Ra sub-group having refractive power, and a first Rb sub-group having negative refractive power,
the intermediate image is formed between the first Ra sub-group and the first Rb sub-group, and
in a case where a focal length of the first Ra sub-group is denoted by f1Ra,
a focal length of the first Rb sub-group is denoted by f1Rb, and
in a case where the imaging optical system is a variable magnification optical system, f1Ra and f1Rb are values at the wide-angle end,
Conditional Expression (11) is satisfied, which is represented by

$$- 1.5 < f 1 Ra / f 1 Rb < - 0.5 . \qquad ( 11 )$$

### Appendix 16

The imaging optical system according to Appendix 15,
in which the first Rb sub-group consists of one or two lenses.

### Appendix 17

The imaging optical system according to any one of Appendices 14 to 16,
in which a focus group that moves during focusing is disposed in only the first F group, and
in a case where a ray emitted at a bisector of an angle formed by an upper ray and a lower ray among rays emitted from a maximum image height of the reduction-side imaging plane to the magnification side is defined as an intermediate ray,
the intermediate ray intersects with the optical axis in the focus group.

### Appendix 18

The imaging optical system according to Appendix 17,
in which the focus group consists of two groups that move by changing mutual spacings during focusing, and
in focusing from a short range to a long range, a group on the magnification side out of the two groups moves to the reduction side.

### Appendix 19

A projection type display device comprising:
the imaging optical system according to any one of Appendices 1 to 18.

### Appendix 20

An imaging apparatus comprising:
the imaging optical system according to any one of Appendices 1 to 18.

What is claimed is:

1. An imaging optical system that conjugates a reduction-side imaging plane and a magnification-side imaging plane each other,
forms, in the imaging optical system, an intermediate image at a position conjugate to the magnification-side imaging plane, and
consists of, in order from a magnification side to a reduction side along an optical path, a first optical system and a second optical system,
wherein the first optical system and the second optical system are separated by a maximum air spacing among air spacings between lenses on an optical axis on the reduction side with respect to the intermediate image,
the first optical system includes a lens surface having a concave shape adjacent to the intermediate image on the magnification side, and a lens surface having a concave shape adjacent to the intermediate image on the reduction side,
a lens surface of the first optical system closest to the reduction side has a concave shape, and
in a case where an air spacing on the optical axis between the first optical system and the second optical system is denoted by Dair,
a distance on the optical axis from a lens surface of the first optical system closest to the magnification side to a lens surface of the second optical system closest to the reduction side is denoted by DAL,
a distance on the optical axis from the lens surface of the first optical system closest to the magnification side to the lens surface of the first optical system closest to the reduction side is denoted by DG1,
a distance on the optical axis from a lens surface of the second optical system closest to the magnification side to the lens surface of the second optical system closest to the reduction side is denoted by DG2, and
in a case where the imaging optical system is a variable magnification optical system, Dair, DAL, DG1, and DG2 are values at a wide-angle end,
Conditional Expressions (1) and (2) are satisfied, which are represented by
$$0.11 < Dair / DAL < 0.25 and \qquad ( 1 )$$
$$1 < DG 1 / DG 2 < 2.4 . \qquad ( 2 )$$

2. The imaging optical system according to claim 1,
wherein a maximum half angle of view is 45 degrees or more, and
in a case where the imaging optical system is a variable magnification optical system, the maximum half angle of view is a value at the wide-angle end.

3. The imaging optical system according to claim 1,
wherein the lens surface of the second optical system closest to the magnification side has a concave shape.

4. The imaging optical system according to claim 1,
wherein the imaging optical system is a zoom lens in which a moving lens group that moves during a change in magnification is included in the second optical system.

5. The imaging optical system according to claim 4,
wherein the second optical system includes, in consecutive order from the magnification side to the reduction side along the optical path, a first moving lens group having positive refractive power, a second moving lens group having refractive power, and a third moving lens group having refractive power, and
during a change in the magnification, a spacing between the first moving lens group and the second moving lens group changes, and a spacing between the second moving lens group and the third moving lens group changes.

6. The imaging optical system according to claim 5,
wherein each of the second moving lens group and the third moving lens group has positive refractive power.

7. The imaging optical system according to claim 5,
wherein in a case where a focal length of the first moving lens group is denoted by fz1, and
a focal length of the second moving lens group is denoted by fz2,
Conditional Expression (3) is satisfied, which is represented by
$$0 < \vert fz 1 / fz 2 \vert < 1. \qquad ( 3 )$$

8. The imaging optical system according to claim 5,
wherein in a case where a focal length of the first moving lens group is denoted by fz1, and
a focal length of the third moving lens group is denoted by fz3,
Conditional Expression (4) is satisfied, which is represented by
$$0 < \vert f z 1 / f z 3 \vert < 1.5 . \qquad ( 4 )$$

9. The imaging optical system according to claim 4,
wherein a lens closest to the magnification side in the second optical system remains stationary with respect to the reduction-side imaging plane during a change in the magnification.

10. The imaging optical system according to claim 1,
wherein the second optical system includes, closest to the magnification side, an optical path bending member that bends the optical path.

11. The imaging optical system according to claim 1,
wherein in a case where a focal length of the first optical system is denoted by f1,
a focal length of the imaging optical system is denoted by f, and
in a case where the imaging optical system is a variable magnification optical system, f1 and f are values at the wide-angle end,
Conditional Expression (5) is satisfied, which is represented by
$$0.7 < \vert f 1 / f \vert < 1.4 . \qquad ( 5 )$$

12. The imaging optical system according to claim 1,
wherein in a case where a focal length of the first optical system is denoted by f1,
a focal length of the second optical system is denoted by f2, and
in a case where the imaging optical system is a variable magnification optical system, f1 and f2 are values at the wide-angle end,
Conditional Expression (6) is satisfied, which is represented by
$$0.01 < \vert f 1 / f 2 \vert < 0.25 . \qquad ( 6 )$$

13. The imaging optical system according to claim 1,
wherein the second optical system includes at least one positive lens, and
in a case where a refractive index of the positive lens of the second optical system at a d line is denoted by N2p,
an Abbe number of the positive lens of the second optical system at the d line is denoted by v2p,
a temperature coefficient, at a temperature of 20° C., of the refractive index of the positive lens of the second optical system at the d line is denoted by (dN2p/dT)×10⁻⁶, and
a unit of dN2p/dT is ° C.⁻¹,
the second optical system includes at least one positive lens satisfying Conditional Expressions (7), (8), and (9) represented by
$$1.4 < N 2 p < 1.55 , \qquad ( 7 )$$
$$66 < v 2 p < 100 , and \qquad ( 8 )$$
$$0 < dN 2 p / dT < 10. \qquad ( 9 )$$

14. The imaging optical system according to claim 1,
wherein the first optical system consists of, in order from the magnification side to the reduction side along the optical path, a first F group and a first R group that are separated by a maximum air spacing on the optical axis in the first optical system,
the intermediate image is formed in the first R group, and
in a case where a focal length of the first F group is denoted by f1F,
a focal length of the first R group is denoted by f1R, and
in a case where the imaging optical system is a variable magnification optical system, f1F and f1R are values at the wide-angle end,
Conditional Expression (10) is satisfied, which is represented by
$$0.25 < f 1 F / f 1 R < 0.75 . \qquad ( 10 )$$

15. The imaging optical system according to claim 14,
wherein the first R group consists of, in order from the magnification side to the reduction side along the optical path, a first Ra sub-group having refractive power, and a first Rb sub-group having negative refractive power,
the intermediate image is formed between the first Ra sub-group and the first Rb sub-group, and
in a case where a focal length of the first Ra sub-group is denoted by f1Ra,
a focal length of the first Rb sub-group is denoted by f1Rb, and
in a case where the imaging optical system is a variable magnification optical system, f1Ra and f1Rb are values at the wide-angle end,
Conditional Expression (11) is satisfied, which is represented by
$$- 1.5 < f 1 Ra / f 1 Rb < - 0.5 . \qquad ( 11 )$$

16. The imaging optical system according to claim 15,
wherein the first Rb sub-group consists of one or two lenses.

17. The imaging optical system according to claim 14,
wherein a focus group that moves during focusing is disposed in only the first F group, and
in a case where a ray emitted at a bisector of an angle formed by an upper ray and a lower ray among rays emitted from a maximum image height of the reduction-side imaging plane to the magnification side is defined as an intermediate ray,
the intermediate ray intersects with the optical axis in the focus group.

18. The imaging optical system according to claim 17,
wherein the focus group consists of two groups that move by changing mutual spacings during focusing, and
in focusing from a short range to a long range, a group on the magnification side out of the two groups moves to the reduction side.

19. A projection type display device comprising:
the imaging optical system according to claim 1.

20. An imaging apparatus comprising:
the imaging optical system according to claim 1.
